(19) United States
(12) Patent Application Publication
(10) Pub. No.: US 2015/0233536 A1
(43) Pub. Date: Aug. 20, 2015

(54) PHOSPHOR-COATED ELEMENT IN A LAMP CAVITY

(71) Applicant: SORAA, Inc., Fremont, CA (US)

(72) Inventors: MICHAEL RAGAN KRAMES, Mountain View, CA (US); Aurelien J.F. David, San Francisco, CA (US)

(21) Appl. No.: 14/703,032

(22) Filed: May 4, 2015

Related U.S. Application Data
(63) Continuation-in-part of application No. 14/628,562, filed on Feb. 23, 2015.
Application No. 14/628,562 is a continuation of application No. 13/856,613, filed on Apr. 4, 2013, now Pat. No. 8,985,794.
(60) Provisional application No. 61/625,592, filed on Apr. 17, 2012.

(51) Int. Cl. F21K 99/00; F21V 3/04; F21V 5/04

(52) U.S. Cl. CPC F21K 9/56; F21V 5/048; F21V 3/0436; F21Y 2105/001

(57) ABSTRACT

Light emitting devices and techniques for using phosphor-coated optical elements in a lamp cavity are disclosed.

This application is a continuation-in-part of U.S. application Ser. No. 14/628,562 filed on Feb. 23, 2015, which is a continuation of U.S. application Ser. No. 13/856,613 filed on Apr. 4, 2013, which claims the benefit under 35 U.S.C. §119(e) of U.S. Provisional Application No. 61/625,592 filed on Apr. 17, 2012, each of which is incorporated by reference in its entirety.

### FIELD

The present disclosure relates generally to light emitting devices and, more particularly, to techniques for using phosphor-coated elements in a lamp cavity.

### BACKGROUND

Legacy LED light bulbs and fixtures use blue-emitting diodes in combination with phosphors or other wavelength-converting materials emitting red, and/or green, and/or yellow light. Various attempts and techniques found in legacy techniques have proven ineffective and/or inefficient. For example, use of green- and/or yellow-emitting materials to coat the structures (e.g., bulb structures) often consumes a large amount of wavelength converting materials. In other legacy situations, LEDs are used in conjunction with down-converting phosphors embedded in an encapsulant, which encapsulant is disposed directly atop or in close proximity to the LEDs. However short wavelength light is known to degrade the materials used in encapsulants, thus limiting the useful lifetime of the lamp.

What is needed is a way to produce a pleasing light while avoiding or mitigating the deficiencies of the legacy techniques. What is needed is an LED lighting system that disposes wavelength converting material in a location that is suitably remote from the LEDs (e.g., so as to reduce the degradation effects) while still avoiding inefficient use of wavelength-converting materials as described above, and while still producing a pleasing light.

What is needed is a way to implement remote wavelength-converting materials in a cavity, such as is described below.

### SUMMARY

Improved approaches involving the use of LEDs together with remote wavelength-converting materials in a cavity is provided herein.

In a first aspect, LED lighting systems are provided comprising one or more LEDs disposed on a mounting member, wherein the one or more LEDs emitting a pump light, and wherein the one or more LEDs have respective base areas, and wherein a sum of the base areas cover a first area; and an optical element optically coupled to the pump light, wherein at least one region of the optical element comprises wavelength-conversion material covering a second area, and wherein the wavelength-conversion material emits converted light upon excitation by the pump light, and wherein the optical element is formed using a non-opaque material that is transparent to the pump light and the converted light, and wherein the optical element has a material composition, shape, and dimensions to direct at least 80% of the pump light upon the wavelength-conversion material by total internal reflection and to direct at most 25% of the converted light upon the LEDs, and wherein the second area is at least four times greater than the first area.

In a second aspect, LED lighting systems having a package efficiency are provided, the LED lighting system comprising one or more LEDs disposed on a mounting member, wherein the one or more LEDs emitting a pump light, and wherein the one or more LEDs have respective base areas, and wherein a sum of the base areas cover a first area; and an optical element optically coupled to the pump light, wherein at least one region of the optical element comprises wavelength-conversion material covering a second area, and wherein the wavelength-conversion material emits converted light upon excitation by the pump light, and wherein the optical element is formed using a non-opaque material that is transparent to the pump light and the converted light, and wherein the optical element has a material composition, shape, and dimensions to direct at least 80% of the pump light upon the wavelength-conversion material by total internal reflection and to direct at most 25% of the converted light upon the LEDs, and wherein the second area is at least four times greater than the first area; and wherein the package efficiency is at least 90%.

### BRIEF DESCRIPTION OF THE DRAWINGS

FIG. 1A is a diagram illustrating an LED lamp, according to some embodiments.

FIG. 1B is a diagram of an LED lamp, according to some embodiments.

FIG. 1C is a diagram illustrating construction of a radiation source comprised of light emitting diodes, according to some embodiments.

FIG. 1D is a diagram illustrating an optical device embodied as a light source constructed using an array of LED devices, according to some embodiments.

FIG. 1E is a side view illustrating a remote dome for generating white light, according to an embodiment of the disclosure.

FIG. 1F is a side view illustrating a remote dome for generating white light, according to an embodiment of the disclosure.

FIG. 2A is a diagram illustrating a construction technique of an optical device having phosphor materials on a filament, according to an embodiment of the present disclosure.

FIG. 2B is a diagram illustrating a construction technique of an optical device having phosphor materials on a filament, according to an embodiment of the present disclosure

FIG. 3A is a diagram illustrating a conversion process, according to some embodiments.

FIG. 3B is a diagram illustrating a conversion process, according to some embodiments.

FIG. 4 is a graph illustrating a light process chart by phosphor material, according to some embodiments.

FIG. 5 is an illustration of an LED lamp housing having coated interior portions, according to an embodiment of the present disclosure.

FIG. 6 is an illustration of an LED lamp housing having coated planar portions, according to an embodiment of the present disclosure.

FIG. 7A features an optical element, according to an embodiment of the disclosure.

FIG. 7B features an optical element configured such that at least 90% of the light emitted by the LEDs reaches the output port.

FIG. 7C details the trajectories of various converted light rays emitted by the wavelength-converted material.

FIG. 7D illustrates the conversion material on a shaped concave surface.

FIG. 7E illustrates the conversion material on a shaped convex surface.

FIG. 7F illustrates the conversion material placed on the sides of the TIR lens as well as the top to increase the amount of side light.

FIG. 8 shows such an embodiment wherein several relatively smaller optical elements are formed.

FIG. 9A shows an encapsulating optical element, according to some embodiments.

FIG. 9B shows an elongated optical element, according to some embodiments.

FIG. 9C shows the converting material is also formed over the sidewalls of the optical element, according to some embodiments.

FIG. 9D shows the optical element is terminated by a larger volume, according to some embodiments.

FIG. 9E shows an optical element having wedged sidewalls, according to some embodiments.

FIG. 10A shows an embodiment with a curved section and a straight section.

FIG. 10B shows, an embodiment that appears to human viewer as filaments.

FIG. 11 depicts an embodiment with a reflective mirror.

FIG. 12 depicts an air flow embodiment.

FIG. 13A depicts an embodiment having reflective elements placed at the sides of the LED, according to some embodiments.

FIG. 13B depicts an optical element where the LED is encapsulated and placed in an optical element with an air cavity, according to some embodiments.

FIG. 14A1, FIG. 14A2, and FIG. 14A3 depict a light conversion processes involving interrogation of a scattering wavelength-converting member by organized light, according to some embodiments.

FIG. 14B depicts a light conversion process involving interrogation of a phosphor-coated filament-like member and a selectively-reflective layer, according to some embodiments.

FIG. 15 presents a selection of lamp shapes.

### DETAILED DESCRIPTION OF THE DISCLOSURE

Various types of phosphor-converted (pc) light-emitting diodes (LEDs) have been proposed in the past. Conventional pc LEDs include a blue LED with various phosphors (e.g., in yellow and red combinations; in green and red combinations; and in red, green, and blue combinations). Various attempts have been made to combine the blue light-emissions of the blue LEDs with phosphors to provide color control.

According to some embodiments of the present disclosure, a substantially white light lamp is formed by combining wavelength-converting material that emit substantially blue light (e.g., phosphors) with LEDs that emit red, green, and/or violet (but not blue) light. In some embodiments, the combination is provided in a form factor to serve as an LED light source (e.g., a light bulb, a lamp, a fixture, etc.).

Table 1 shows an example of various LED pump- and phosphor-emitting peak wavelengths that could be used to generate white light according to embodiments provided by the present disclosure.

TABLE 1

| | | | Yellow/ | |
|---|---|---|---|---|
| | | Blue | Green | Red |
| Emission Peak | (nm) | 450 | 530 | 620 |
| LED Pump | (nm) | 400-420 | 415-435 | 415-435 |

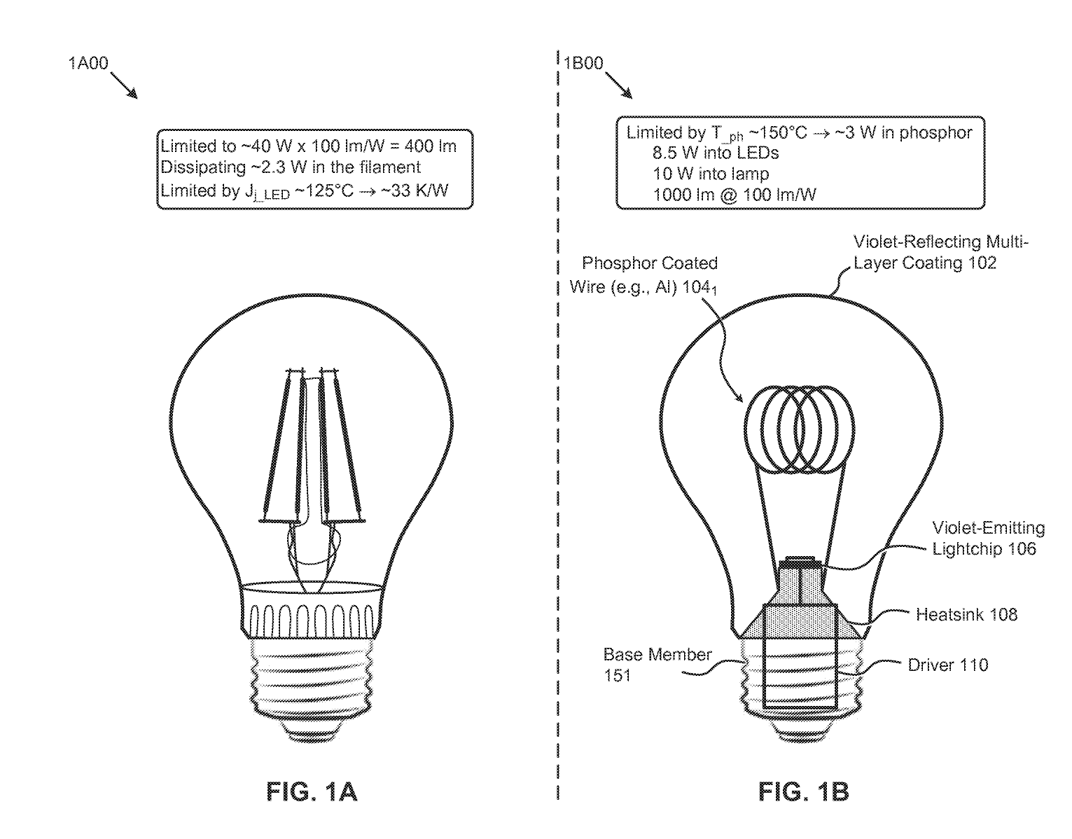

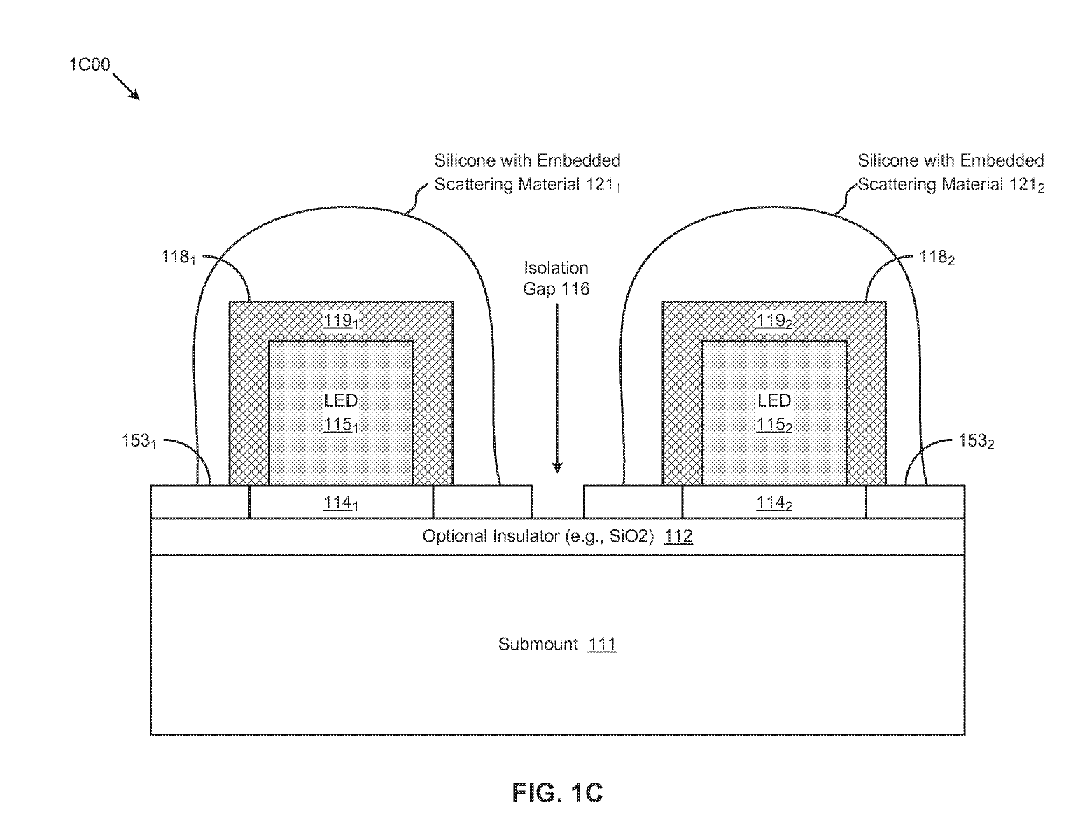

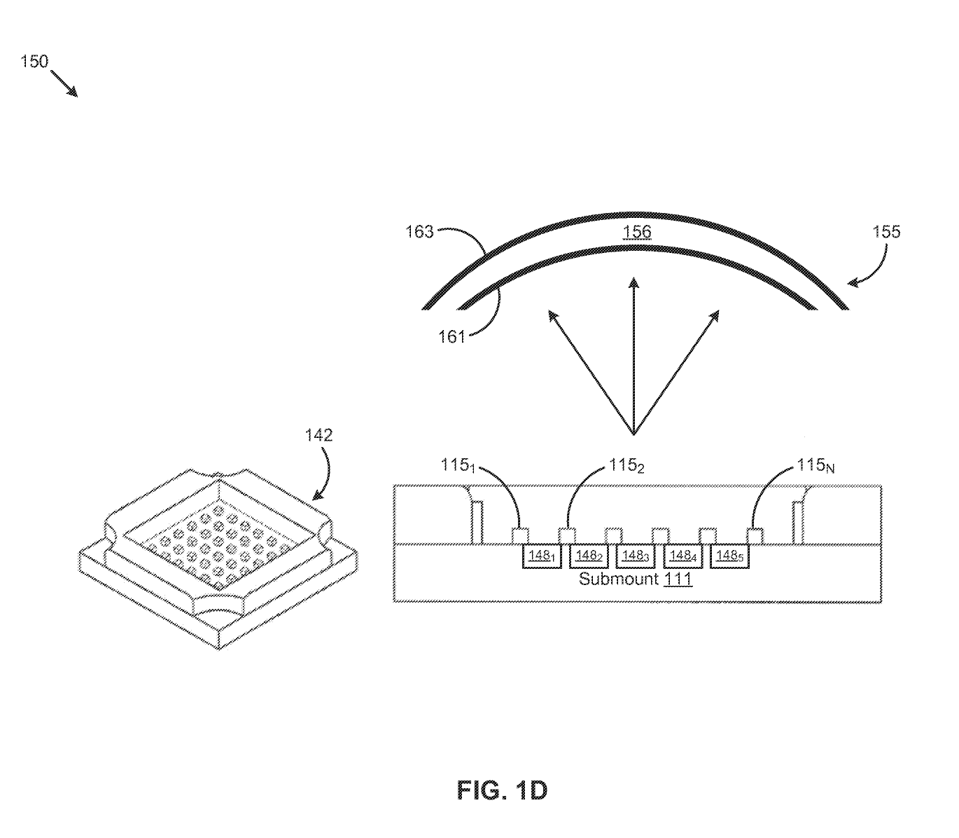

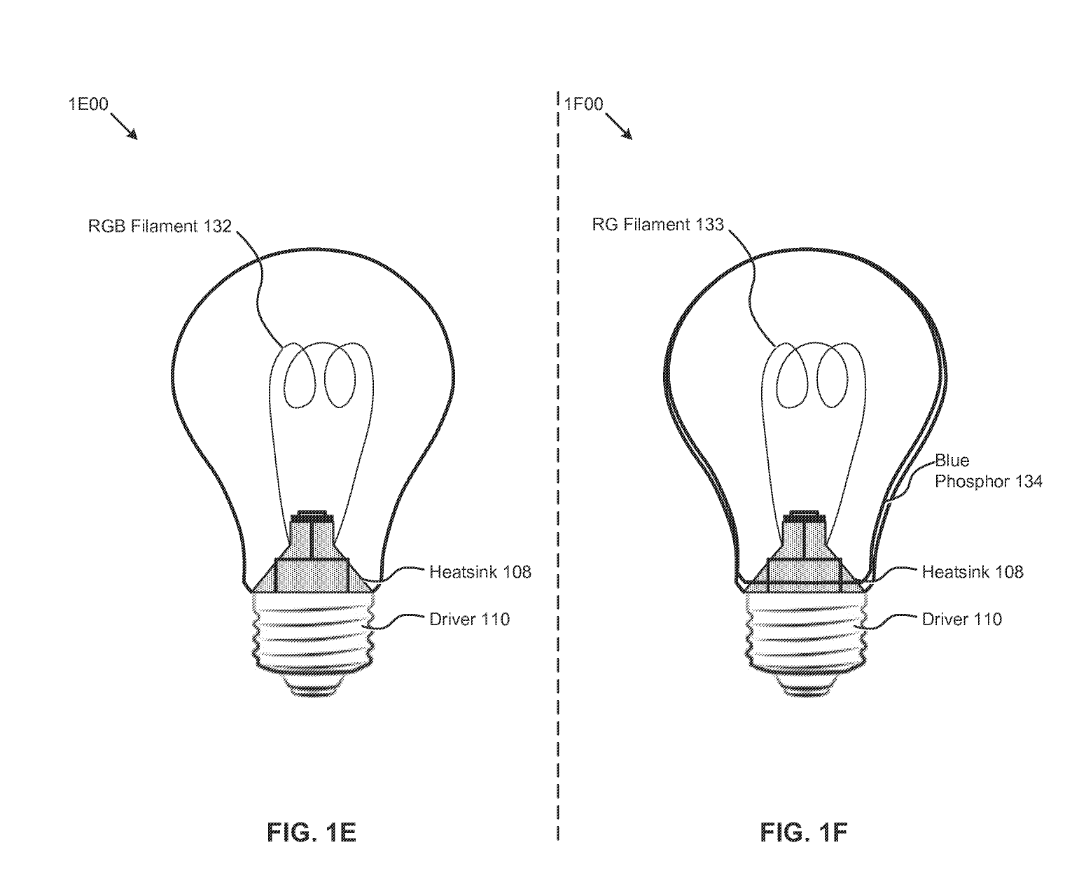

FIG. 1A is a diagram illustrating an LED lamp 1A00. Here the LEDs are placed on holders which mimic filaments, and are coated with phosphor. The lamp is limited in its maximum optical output to about 400 lm—this is due to the poor thermal dissipation of the heat generated by the LEDs. LED lamps with higher optical output (such as 600 lm, 800 lm, 1000 lm or more) are desirable to replace some existing filament lamps.

FIG. 1B is a diagram of an LED lamp 1B00. The shown embodiments includes a violet-emitting light source 106, a heatsink 108, a phosphor-coated wire (e.g., 104₁, 104₂, 104₃, etc.), an violet-reflecting multi-layer coating 102, and a driver 110 disposed within a base member 151. The foregoing active and passive elements interact to produce a light emission result. Many such interactions and combinations of the active and passive elements are discussed in detail below. This embodiment is advantageous over that of FIG. 1A, in that the heat from the LEDs can be efficiently dissipated (e.g., via a heat sink). Therefore the system can be driven to a higher power and may emit 1000 lm, for instance.

The base member 151 can conform to any of a set of standards for the base. For example Table 2 gives standards (see “Designation”) and corresponding characteristics.

TABLE 2

| | | | | IEC |
|---|---|---|---|---|
| | | | | 60061-1 |
| Desig- | Base Diameter | | | Standard |
| nation | (crest of thread) | | Name | Sheet |
| E05 | 5 | mm | Lilliput Edison Screw (LES) | 7004-25 |
| E10 | 10 | mm | Miniature Edison Screw (MES) | 7004-22 |
| E11 | 11 | mm | Mini-Candelabra Edison Screw | (7004- |
| | | | (mini-can) | 6-1) |
| E12 | 12 | mm | Candelabra Edison Screw (CES) | 7004-28 |
| E14 | 14 | mm | Small Edison Screw (SES) | 7004-23 |
| E17 | 17 | mm | Intermediate Edison Screw (IES) | 7004-26 |
| E26 | 26 | mm | [Medium] (one-inch) Edison Screw | 7004- |
| | | | (ES or MES) | 21A-2 |
| E27 | 27 | mm | [Medium] Edison Screw (ES) | 7004-21 |
| E29 | 29 | mm | [Admedium] Edison Screw (ES) | |
| E39 | 39 | mm | Single-contact (Mogul) Giant Edison | 7004- |
| | | | Screw (GES) | 24-A1 |
| E40 | 40 | mm | (Mogul) Giant Edison Screw (GES) | 7004-24 |

Additionally, the base member can be of any form factor configured to support electrical connections, which electrical connections can conform to any of a set of types or standards. For example Table 3 gives standards (see “Type”) and corresponding characteristics, including mechanical spacing between a first pin (e.g., a power pin) and a second pin (e.g., a ground pin).

TABLE 3

| | | Pin | | | | |
|---|---|---|---|---|---|---|
| | | (center to | | | | |
| Type | Standard | center) | | Pin Diameter | | Usage |
| G4 | IEC 60061- | 4.0 | mm | 0.65-0.75 | mm | MR11 and other small halogens of |
| | 1 (7004-72) | | | | | 5/10/20 watt and 6/12 volt |
| GU4 | IEC 60061- | 4.0 | mm | 0.95-1.05 | mm | |
| | 1 (7004-108) | | | | | |
| GY4 | IEC 60061- | 4.0 | mm | 0.65-0.75 | mm | |
| | 1 (7004-72A) | | | | | |
| GZ4 | IEC 60061- | 4.0 | mm | 0.95-1.05 | mm | |
| | 1 (7004-64) | | | | | |
| G5 | IEC 60061- | 5 | mm | | | T4 and T5 fluorescent tubes |
| | 1 (7004-52-5) | | | | | |
| G5.3 | IEC 60061- | 5.33 | mm | 1.47-1.65 | mm | |
| | 1 (7004-73) | | | | | |
| G5.3-4.8 | IEC 60061- | | | | | |
| | 1 (7004-126-1) | | | | | |
| GU5.3 | IEC 60061- | 5.33 | mm | 1.45-1.6 | mm | |
| | 1 (7004-109) | | | | | |
| GX5.3 | IEC 60061- | 5.33 | mm | 1.45-1.6 | mm | MR16 and other small halogens of |
| | 1 (7004-73A) | | | | | 20/35/50 watt and 12/24 volt |
| GY5.3 | IEC 60061- | 5.33 | mm | | | |
| | 1 (7004-73B) | | | | | |
| G6.35 | IEC 60061- | 6.35 | mm | 0.95-1.05 | mm | |
| | 1 (7004-59) | | | | | |
| GX6.35 | IEC 60061- | 6.35 | mm | 0.95-1.05 | mm | |
| | 1 (7004-59) | | | | | |
| GY6.35 | IEC 60061- | 6.35 | mm | 1.2-1.3 | mm | Halogen 100 W 120 V |
| | 1 (7004-59) | | | | | |
| GZ6.35 | IEC 60061- | 6.35 | mm | 0.95-1.05 | mm | |
| | 1 (7004-59A) | | | | | |
| G8 | | 8.0 | mm | | | Halogen 100 W 120 V |
| GY8.6 | | 8.6 | mm | | | Halogen 100 W 120 V |
| G9 | IEC 60061- | 9.0 | mm | | | Halogen 120 V (US)/230 V (EU) |
| | 1 (7004-129) | | | | | |
| G9.5 | | 9.5 | mm | 3.10-3.25 | mm | Common for theatre use, several |
| | | | | | | variants |
| GU10 | | 10 | mm | | | Twist-lock 120/230-volt MR16 |
| | | | | | | halogen lighting of 35/50 watt, since |
| | | | | | | mid-2000s |
| G12 | | 12.0 | mm | 2.35 | mm | Used in theatre and single-end metal |
| | | | | | | halide lamps |
| G13 | | 12.7 | mm | | | T8 and T12 fluorescent tubes |
| G23 | | 23 | mm | 2 | mm | |
| GU24 | | 24 | mm | | | Twist-lock for self-ballasted compact |
| | | | | | | fluorescents, since 2000s |
| G38 | | 38 | mm | | | Mostly used for high-wattage theatre |
| | | | | | | lamps |
| GX53 | | 53 | mm | | | Twist-lock for puck-shaped under- |
| | | | | | | cabinet compact fluorescents, since |
| | | | | | | 2000s |

FIG. 1C is a diagram illustrating construction of a radiation source 1C00 comprised of light emitting diodes. As shown, the radiation source is constructed on a submount 111 upon which submount is a layer of sapphire or other optional insulator 112, upon which are disposed one or more conductive contacts (e.g., conductive contact 114₁, conductive contact 114₂), arranged in an array where each conductive contact is spatially separated from other conductive contacts by an isolation gap 116. Further disposed atop the submount or atop the insulator are one or more deposits (e.g., deposit 153₁, deposit 153₂) of wavelength-modifying material configured to modify the color of the light generated by LED devices. Various mixes of colors can be achieved using a deposit (e.g., deposit 153₁, deposit 153₂) of wavelength-modifying material disposed in proximity to the radiation sources.

FIG. 1C shows LED devices in a linear array, however other array configurations are possible, for example, as described herein. As shown, atop the conductive contacts are LED devices (e.g., LED device 115₁, LED device 115₂). The LED device is but one possibility for a radiation source, and other radiation sources are possible and envisioned, for example a radiation source can be a laser device.

In certain embodiments, the devices and packages disclosed herein an LED (or laser) disposed on a submount. The starting materials can comprise polar, semipolar or non-polar gallium nitride containing materials.

The radiation source is not to be construed as conforming to a specific drawing scale, and in particular, many structural details are not included in FIG. 1C so as not to obscure understanding of the embodiments. The isolation gap serves to facilitate shaping of materials formed in and around the isolation gap, which formation can be by one or more additive processes, or by one or more subtractive processes, or both.

It is to be appreciated that the radiation sources illustrated in FIG. 1C can output light in a variety of wavelengths (e.g., colors) according to various embodiments of the present disclosure. Depending on the application, color balance can be achieved by modifying color generated by LED devices and/or configuring and using wavelength-modifying material (e.g., a phosphor material).

In certain embodiments, color balance can be achieved by modifying the color of the light generated by LED devices by using a deposit (e.g., deposit 153₁, deposit 153₂) of wavelength-modifying material disposed in proximity to the radiation source.

In certain embodiments, the phosphor material may be mixed into a surrounding encapsulant structure (e.g., 119₁, 119₂) such as a silicone material (e.g., see encapsulating material 118₁, encapsulating material 118₂) instead of or in addition to other encapsulants (e.g., silicone with embedded scattering material 121₁, silicone with embedded scattering material 121₂) that is disposed atop and/or surrounding any one or more faces of the LED devices in the array of LED devices. Other embodiments for providing color pixels can be conveniently constructed using techniques that form deposits of one or more wavelength-modifying materials.

As is known in the art, silicone degrades more quickly when exposed to a high flux of higher-energy photons (e.g., shorter wavelength light). Thus, embodiments that employ lower energy radiation sources (e.g., red or green LEDs) reduce the rate of degradation of the silicone components of an LED lamp. Embodiments employing red and green LEDs are further discussed herein.

FIG. 1D is a diagram illustrating an optical device 150 embodied as a light source 142 constructed using an array of LED devices (e.g., LED device 115₁, LED device 115₂, LED device 115_{N}, etc.) juxtaposed with a remotely-located instance of a remote structural member 155, the remote structural member 155 having instances of wavelength converting materials (e.g., pixels, deposits) distributed upon or within the volume 156 of the remote structural member 155, which volume is bounded by a remote structural member inner surface 161 and a remote structural member outer surface 163, according to certain embodiments. LED devices are mounted on submount 111.

In addition to the wavelength converting materials distributed upon or within the volume 156 of the remote structural member 155, some embodiments include deposits of wavelength converting materials disposed in close proximity to the LED devices. As shown, wavelength-modifying material (e.g., deposit 148₁, deposit 148₂, deposit 148₃, deposit 148₄, deposit 148₅, etc.) can be disposed and distributed in a variety of configurations, including being deposited in a cup structure, or being deposited in a layer disposed atop the LED device.

Individually and together, these color pixels modify the color of light emitted by the LED devices. For example, the color pixels are used to modify the light from LED devices to appear as white light having a uniform broadband emission (e.g., characterized by a substantially flat emission of light throughout the range of about 380 nm to about 780 nm), which is suitable for general lighting. FIG. 1E is a side view illustrating a remote dome for generating white light 1E00, which includes an RGB filament 132, embodied as a wire coated with red-, green- and blue-emitting phosphors that coat the inside of the bulb-boundary. FIG. 1E also includes heatsink 108 and driver 110.

FIG. 1F is a side view illustrating a remote dome for generating white light 1F00, which includes a RG filament 133 wire coated with red- and green-emitting phosphors, heatsink 108, and driver 110. A blue-emitting phosphor 134 is provided as a layer on the dome.

The combination of the colors of the light emissions from the radiation sources produces white-appearing light. For example, the embodiment as shown can comprise violet LEDs in combination with yellow-emitting and/or green-emitting down-converting materials as disposed in encapsulants, or as disposed in deposits 153₁ and 153₂ of wavelength-modifying material 148 (see FIG. 1C and FIG. 1D). Additionally, blue-emitting down-converting materials are disposed in or on the dome, which blue-emitting down-converting materials absorb violet emissions. The combination of emissions from these sources results in an aggregate color tuning that produces a white-appearing light.

The selected embodiments of bulbs having a remote blue phosphor dome for generating white light are merely exemplary. Other bulb types are envisioned and possible. Table 4 list a subset of possible bulb types for LED lamps.

TABLE 4

| Bulb | |
|---|---|
| Category | Type |
| Incandescent | A-Shape |
| | Candle Bulb |
| | Globe |
| | Bulged Reflector |
| | B-Type |
| | BA-Type |
| | G-Type |
| | J-Type |
| | S-Type |
| | SA-Type |
| | F-Type |
| | T-Type |
| | Y-Type |
| Fluorescent | T-4 |
| | T-5 |
| | T-8 |
| | T-12 |
| | Circline |
| ANSI | ANSI C |
| | ANSI G |
| Halogen | A-Type |
| | Aluminum Reflector |
| | Post Lamps |
| | (e.g., BT15) |
| | MR |
| | PAR |
| | Bulged Reflector |
| HID | ED-Type |
| | ET-Type |
| | B-Type |
| | BD-Type |
| | T-Type |
| | E-Type |
| | A-Type |
| | BT-Type |
| CFL | Single Twin Tube |
| | Double Twin Tube |
| | Triple Twin Tube |
| | Spiral |

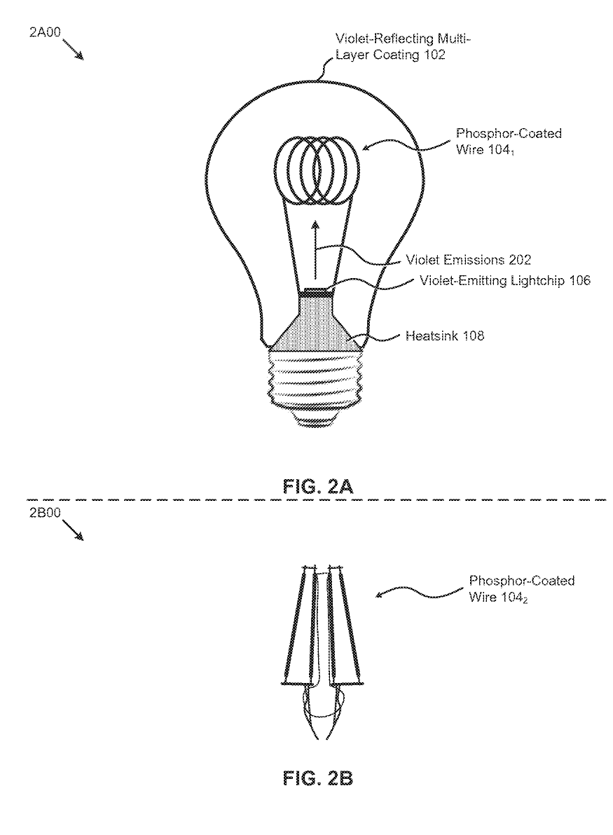

FIG. 2A is a diagram illustrating a construction technique 2A00 of an optical device having phosphor materials on a filament 104₁, which phosphor materials are impinged by violet emissions 202, from violet-emitting lightchip 106, mounted on heatsink 108, according to an embodiment of the present disclosure.

FIG. 2B is a diagram illustrating a construction technique 2B00 of an optical device having phosphor materials on a filament 104₂, according to an embodiment of the present disclosure.

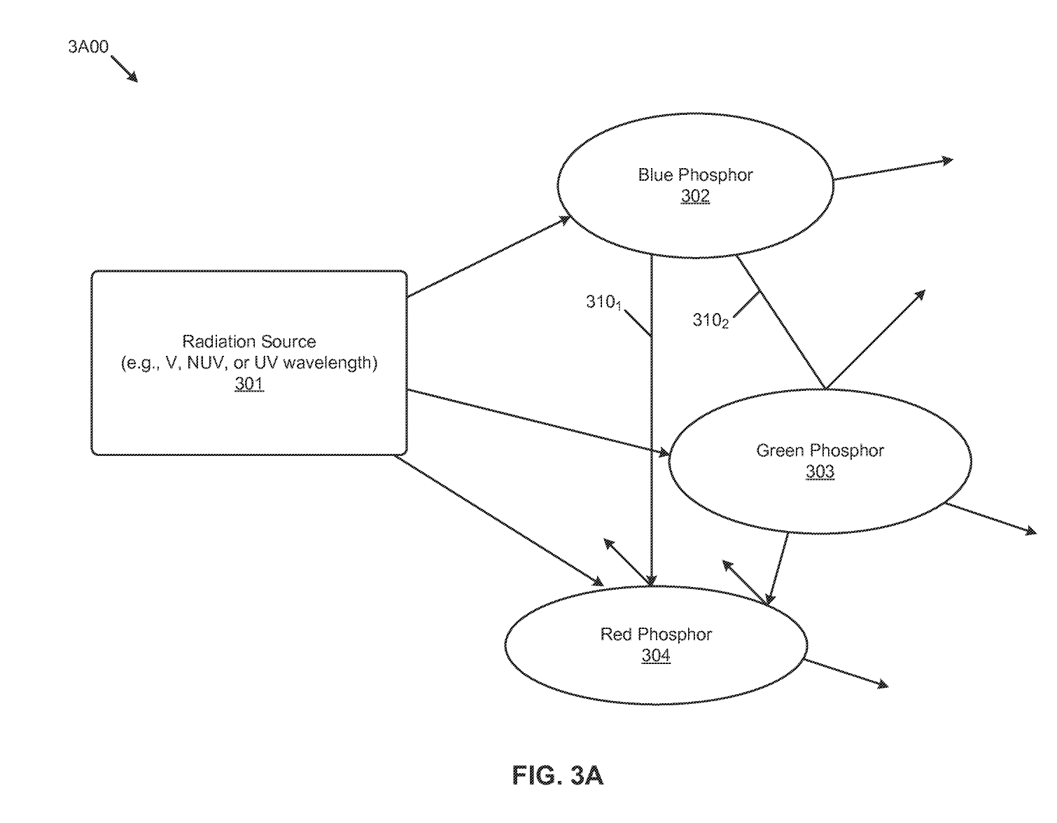

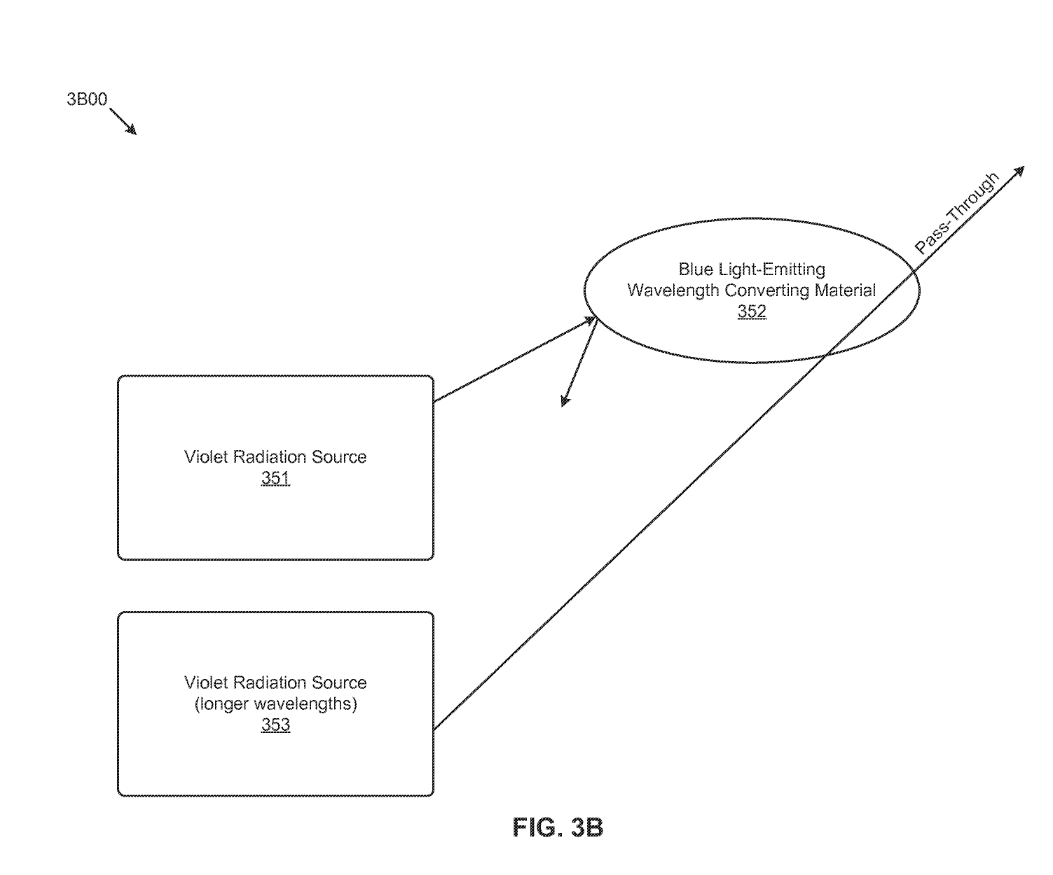

FIG. 3A is a diagram illustrating a conversion process 3A00. As shown, a radiation source 301 is configured to emit radiation at violet, near ultraviolet, or UV wavelengths. The radiation emitted by radiation source 301 is absorbed by the phosphor materials (e.g., the blue phosphor material 302, the green phosphor material 303, and the red phosphor material 304). Upon absorbing the radiation, the blue phosphor material 302 emits blue light, the green phosphor material 303 emits green light, and the red phosphor material 304 emits red light. As shown, a portion (e.g., portion 310₁, portion 310₂) of the emissions from the blue phosphor are incident on the surrounding phosphors, and are absorbed by the green phosphor material and red phosphor material, which emits green and red light, respectively.

FIG. 3B is a diagram illustrating a conversion process 3B00. As shown, a violet radiation source 351 is configured to emit radiation at wavelengths that are shorter than wavelengths in the blue spectrum. The radiation emitted by violet radiation source 351 is reflected by blue light-emitting wavelength converting material 352. And, as shown, the radiation emitted by violet radiation source 353 (longer wavelengths) is transparent to the blue light-emitting wavelength converting material 352, and the radiation emitted by violet radiation source 353 (longer wavelengths) passes through the blue light-emitting wavelength converting material 352.

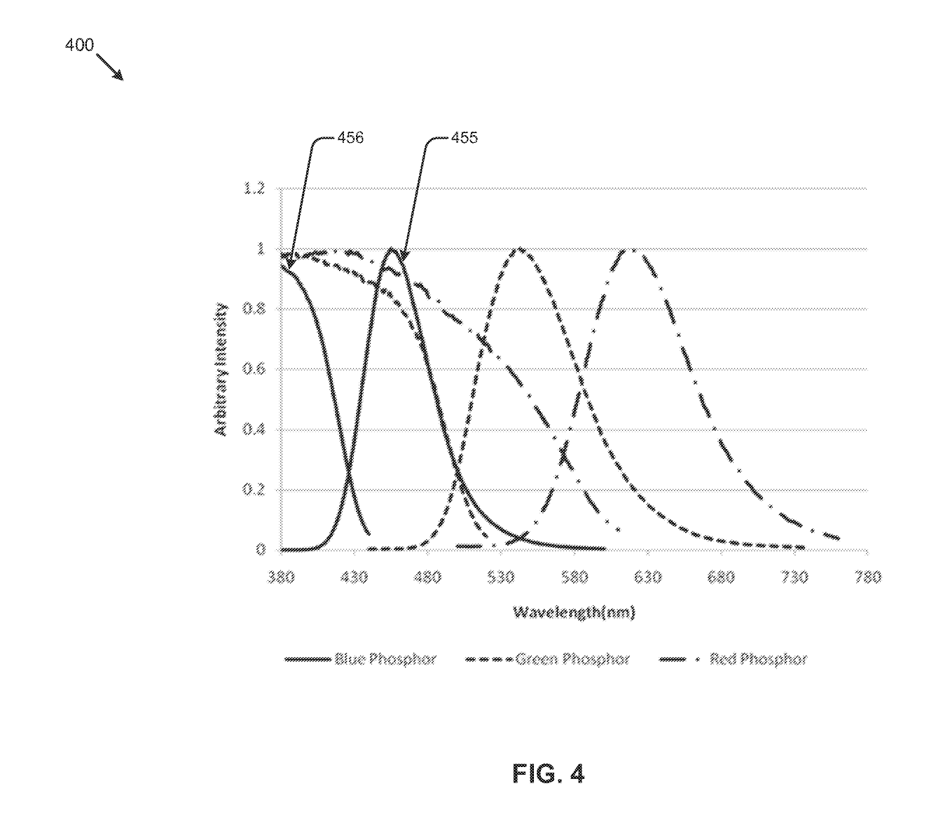

FIG. 4 is a graph illustrating a light process chart 400 by phosphor material. As shown in FIG. 4, radiation with a wavelength of violet, near violet, or ultraviolet from a radiation source is absorbed by the blue phosphor material, which in turn emits blue light. As shown in FIG. 4, each phosphor is most effective at converting radiation at its particular range of wavelength. And, as shown, some of these ranges overlap.

Moreover, as shown, the absorption curves overlap the emission curves to varying degrees. For example, the blue phosphor absorption curve 455 overlaps the blue phosphor emission curve 456 in a wavelength range substantially centered at 430 nm. In certain embodiments, some of the one or more LED devices that are disposed on a light source 142 are configured to emit substantially blue light so that the emitted blue light serves to pump red-emitting and green-emitting phosphors.

It is to be appreciated that embodiments of the present disclosure maintain the benefits of UV- and/or V-pumped pc LEDs while improving conversion efficiency. In one embodiment, an array of LED chips is provided, and is comprised of two groups. One group of LEDs has a shorter wavelength to enable pumping of a blue phosphor material. The second group of LEDs has a longer wavelength which may, or may not, excite a blue phosphor material, but will excite a green or longer wavelength (e.g., red) phosphor material. The combined effect of the two groups of LEDs in the array is to provide light of desired characteristics such as color (e.g., white) and color rendering. Furthermore, the conversion efficiency achieved in some embodiments will be higher than that of the conventional approach. In particular, the cascading loss of blue photons pumping longer-wavelength phosphors may be reduced by localizing blue phosphor to regions near the short-wavelength LEDs. In addition, the longer-wavelength pump LEDs will contribute to overall higher efficacy by being less susceptible to optical loss mechanisms in GaN, metallization, and packaging materials, as described above.

In certain embodiments, a relatively larger number of LED devices that emit wavelengths longer than blue are combined with a relatively smaller number of LED devices that emit wavelengths shorter than blue, and the combination of those radiation sources with a blue-emitting phosphor combine to produce white light.

Wavelength conversion materials can be crystalline (single or poly), ceramic or semiconductor particle phosphors, ceramic or semiconductor plate phosphors, organic or inorganic downconverters, upconverters (anti-stokes), nano-particles and other materials which provide wavelength conversion. Major classes of downconverter phosphors used in solid-state lighting include garnets doped at least with Ce3+; nitridosilicates, oxynitridosilicates or oxynitridoaluminosilicates doped at least with Ce3+; chalcogenides doped at least with Ce3+; silicates or fluorosilicates doped at least with Eu 2+; nitridosilicates, oxynitridosilicates, oxynitridoaluminosilicates or sialons doped at least with Eu2+; carbidonitridosilicates or carbidooxynitridosilicates doped at least with Eu2+; aluminates doped at least with Eu2+; phosphates or apatites doped at least with Eu2+; chalcogenides doped at least with Eu2+; and oxides, oxyfluorides or complex fluorides doped at least with Mn4+. Some specific examples are listed below:

(Ba,Sr,Ca,Mg)₅(PO₄)₃(Cl,F,Br,OH):Eu²⁺, Mn²⁺

(Ca,Sr,Ba)₃MgSi₂O₈:Eu²⁺, Mn²⁺

(Ba,Sr,Ca)MgAl₁₀O₁₇:Eu²⁺, Mn²⁺

(Na,K,Rb,Cs)₂[(Si,Ge,Ti,Zr,Hf,Sn)F₆]:Mn⁴⁺

(Mg,Ca,Zr,Ba,Zn)[(Si,Ge,Ti,Zr,Hf,Sn)F₆]:Mn⁴⁺

(Mg,Ca,Sr,Ba,Zn)₂SiO₄:Eu²⁺

(Sr,Ca,Ba)(Al,Ga)₂S₄:Eu²⁺

(Ca,Sr)S:Eu²⁺,Ce³⁺

(Y,Gd,Tb,La,Sm,Pr,Lu)₃(Sc,Al,Ga)₅O₁₂:Ce³⁺

The group:

Ca₁₋ₓAl_{x-xy}Si_{1-x+xy}N_{2-x-xy}C_{xy}:A (1);

Ca_{1-x-z}Na_{z}M(III)_{x-xy-z}Si_{1-x+xy+z}N_{2-x-xy}C_{xy}:A (2);

M(II)_{1-x-z}M(I)_{z}M(III)_{x-xy-z}Si_{1-x+xy+z}N_{2-x-xy}C_{xy}:A (3);

M(II)_{1-x-z}M(I)_{z}M(III)_{x-xy-z}Si_{1-x+xy+z}N_{2-x-xy-2w/3}C_{xy}O_{w-v/2}Hᵥ:A (4); and

M(II)_{1-x-z}M(I)_{z}M(III)_{x-xy-z}Si_{1-x+xy+z}N_{2-x-xy-2w/3-v/3}C_{xy}O_{w}Hᵥ:A (4a),

wherein 0<x<1, 0<y<1, 0≦z<1, 0≦v<1, 0<w<1, x+z<1, x>xy+z, and 0<x−xy−z<1, M(II) is at least one divalent cation, M(I) is at least one monovalent cation, M(III) is at least one trivalent cation, H is at least one monovalent anion, and A is a luminescence activator doped in the crystal structure.

Ceₓ(Mg,Ca,Sr,Ba)_{y}(Sc,Y,La,Gd,Lu)_{1-x-y}Al(Si_{6-z+y}Al_{z-y})(N_{10-z}O_{z}) (where x,y<1, y≧0 and z˜1)

(Mg,Ca,Sr,Ba)(Y,Sc,Gd,Tb,La,Lu)₂S₄:Ce³⁺

(Ba,Sr,Ca)ₓxSi_{y}N_{z}:Eu2+(where 2x+4y=3z)

(Y,Sc,Lu,Gd)₂₋ₙCaₙSi₄N₆₊ₙC₁₋ₙ:Ce³⁺, (wherein 0≦n≦0.5)

(Lu,Ca,Li,Mg,Y) alpha-SiAlON doped with Eu²⁺ and/or Ce³⁺

(Ca,Sr,Ba)SiO₂N₂:Eu²⁺,Ce³⁺

(Sr,Ca)AlSiN₃:Eu²⁺

CaAlSi(ON)₃:Eu²⁺

(Y,La,Lu)Si₃N₅:Ce³⁺

(La,Y,Lu)₃Si₆N₁₁:Ce³⁺

For purposes of the application, it is understood that when a phosphor has two or more dopant ions (i.e., those ions following the colon in the above phosphors), this is to mean that the phosphor has at least one (but not necessarily all) of those dopant ions within the material. That is, as understood by those skilled in the art, this type of notation means that the phosphor can include any or all of those specified ions as dopants in the formulation. Further, it is to be understood that nanoparticles, quantum dots, semiconductor particles, and other types of materials can be used as wavelength converting materials. The list above is representative and should not be taken to include all the materials that may be used within embodiments described herein.

For purposes of the application, it is understood that when a phosphor has two or more dopant ions (i.e., those ions following the colon in the above phosphors), this is to mean that the phosphor has at least one (but not necessarily all) of those dopant ions within the material. That is, as understood by those skilled in the art, this type of notation means that the phosphor can include any or all of those specified ions as dopants in the formulation. Further, it is to be understood that nanoparticles, quantum dots, semiconductor particles, and other types of materials can be used as wavelength converting materials.

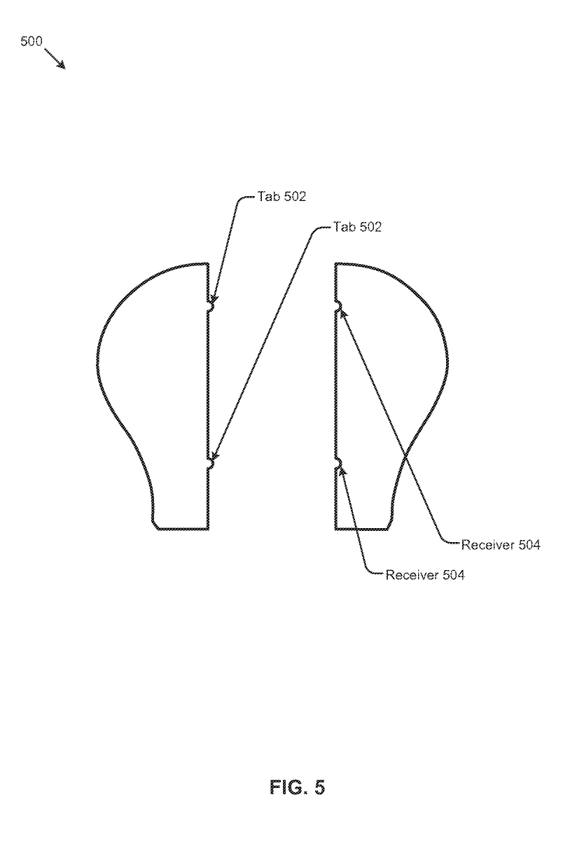

FIG. 5 is an illustration of an LED lamp housing having coated interior portions. The coating can be applied to the curved surface, and multiple portions assembled via mating tabs (see tab 502 and receiver 504) using any known-in-the-art techniques.

A discussion of remote phosphor configurations follows. An LED system can have a remote phosphor configuration, for example, when the wavelength-conversion material is placed far away from the pump LEDs, for instance when it separated from the LEDs by more than a lateral perimeter dimension or radial perimeter dimension of a pump LED. For instance, a system using rectangular 1 mm×1 mm LEDs and a phosphor disposed more than 1 mm away from the LEDs is deemed to embody a remote-phosphor configuration.

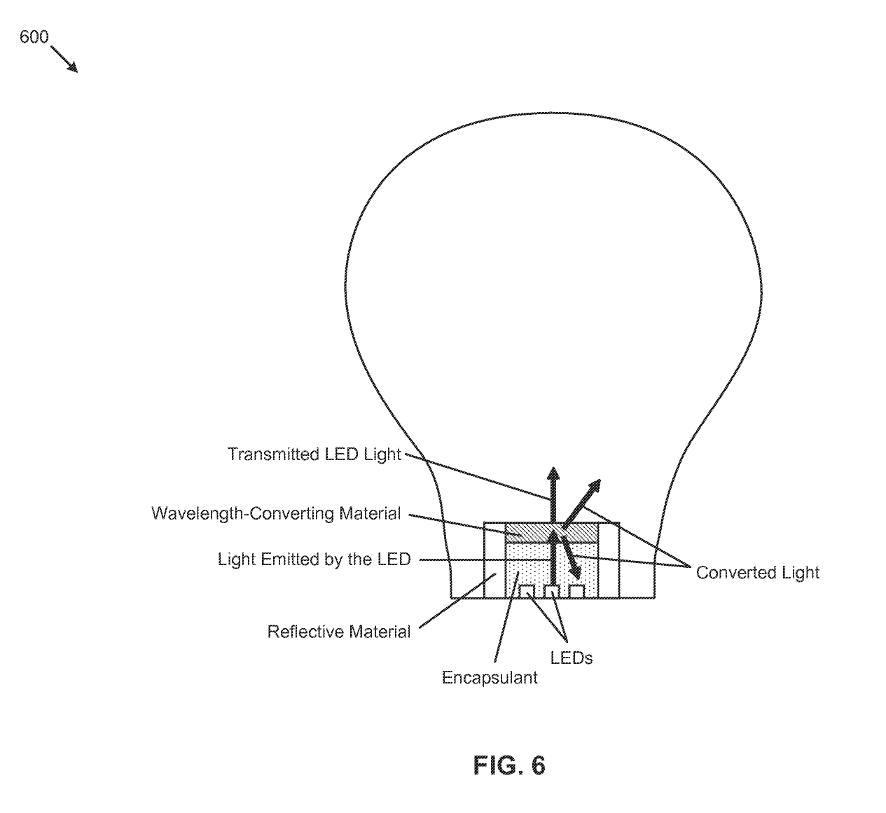

FIG. 6 shows a simplified implementation 600 of a remote phosphor approach. In this example, the implementation is integrated in an A-lamp. The pump LEDs (typically, blue LEDs) are encapsulated in a clear medium such as silicone (or, alternatively, they may be emitting into air). Reflective material is placed around the LEDs. The light emitted by the LEDs reaches the remote wavelength-converting material. A portion of this light is then converted, and another portion is transmitted. The converted light is emitted both towards the exterior and back towards the direction of the LEDs.

Such implementations do not exhibit optimal characteristics for various reasons. First, the light emitted by the LEDs may impinge on the reflective material before reaching the phosphor-converting material, thus causing some optical loss due to the less than perfect reflectivity of the reflective material. Second, a portion of the converted light is emitted back toward the reflective material and the LEDs, where it may incur further optical loss.

It is desirable that the converted light be emitted towards the exterior of the lamp rather than back towards the LEDs, so it should be appreciated that the non-optimal effects expressed above compete such that improvement over one of the non-optimal effects causes degradation on the other non-optimal effect. For example, if the system is configured so that light from the LEDs is more efficiently coupled into the converting material, then the converted light is also more efficiently coupled back into the LEDs. Breaking this symmetric relationship is non-trivial. Embodiments of the invention provide techniques such that converted light is efficiently coupled back into the LEDs. Such efficiency can be measured using various metrics or fractions (e.g., fraction F1, and fraction F2), some of which are presently discussed.

In exemplary embodiments, the fraction F1 of pump light emitted by the pump LEDs which impinges upon the phosphor is typically large, for instance F1=70%, 80%, 90% or more. This is desirable as a large fraction of the pump light has to be converted by the phosphor. The fraction F2 of converted light that is sent back towards the LEDs depends on the specific configuration of the system. However, for the geometry shown on FIG. 6, it can be estimated that about one third of the converted light is sent upward and two thirds of the light is sent downward. In one example (e.g., due to the refractive index of the encapsulant of n˜1.4-1.5), downward emission is increased by a factor n². This large proportion of downward converted light is prone to reach the LEDs and incur loss. Even if air is used rather than an encapsulant, about half of the converted light is send downward. In many remote-phosphor geometries, a large fraction of the converted light (tens of %, sometimes F2=50% or 70% or more) is sent back towards the direction of the LEDs, incurring unwanted losses in the form of hear rather than emitted light.

Therefore, this system is characterized by a fraction F2/F1 which is on the order of one (e.g., ˜1). A large value of F2/F1 indicates that a large amount of converted light is directed back towards the pump LEDs. Small value of F2/F1 indicates that that a small amount of converted light is directed back towards the pump LEDs, which in turn leads to overall efficiency in operation.

The impact of this effect on the overall system efficiency can be quantified by the package efficiency of the system, as will be defined below. The overall efficiency E of the remote phosphor module (discarding extraneous factors like optical efficiency of the lamp housing and electrical efficiency of the electrical driver) can be calculated as the emitted optical power divided by the input electrical power, and may be decomposed as:

E=PCE×QY×ST×PE (EQ. 1)

In this equation EQ. 1, PCE is the power conversion efficiency (also sometimes called wall-plug efficiency) of the pump LEDs—calculated as the optical power emitted by the pump LEDs divided by the electrical power driving the LEDs. QY is the effective quantum yield of the wavelength-conversion material. ST is the Stokes shift caused by converting pump light into longer-wavelength (usually white) light. PE is the package efficiency and represents any additional optical loss, for instance due to converted light being absorbed by the LEDs or other surfaces surrounding the LEDs (submount, reflective material, etc.) or due to backscattered LED light being absorbed by the LEDs or other surfaces surrounding the LEDs.

In the case of FIG. 6, and as discussed, about two thirds of the converted light is sent towards the LED region. A simplified estimate of PE is as follows. If we assume that the LEDs and surrounding surfaces all have a single-bounce reflectivity of 90%, and that the backscattered light will bounce twice before escaping towards the exterior, the package efficiency is PE=⅓+⅔×0.9×0.9=87%. Generally, remote phosphor geometries may have package efficiencies in the range 80-90%. However, it is desirable to achieve higher values such as 90%, 95% or above.

Embodiments of the invention improve over legacy implementations by providing remote-phosphor configurations where (1) a large fraction of the pump light emitted by the LEDs reaches the wavelength-converting material, and (2) only a moderate fraction of the converted light is coupled back toward the LEDs. This results in high values of package efficiency. Additionally, some embodiments of the invention improve upon the quality of the emitted light and upon the system efficiency due to the use of violet pump LEDs.

In certain embodiments, such as are described herein and below, an optical element is used to collect and direct the majority of the primary LED “pump” light toward a wavelength converting material(s) so that a substantial portion of the primary light is converted by the conversion material, and the light emitted by the conversion material is produced with high efficiency (e.g., with low optical losses) and with the light distribution required by the application or product.

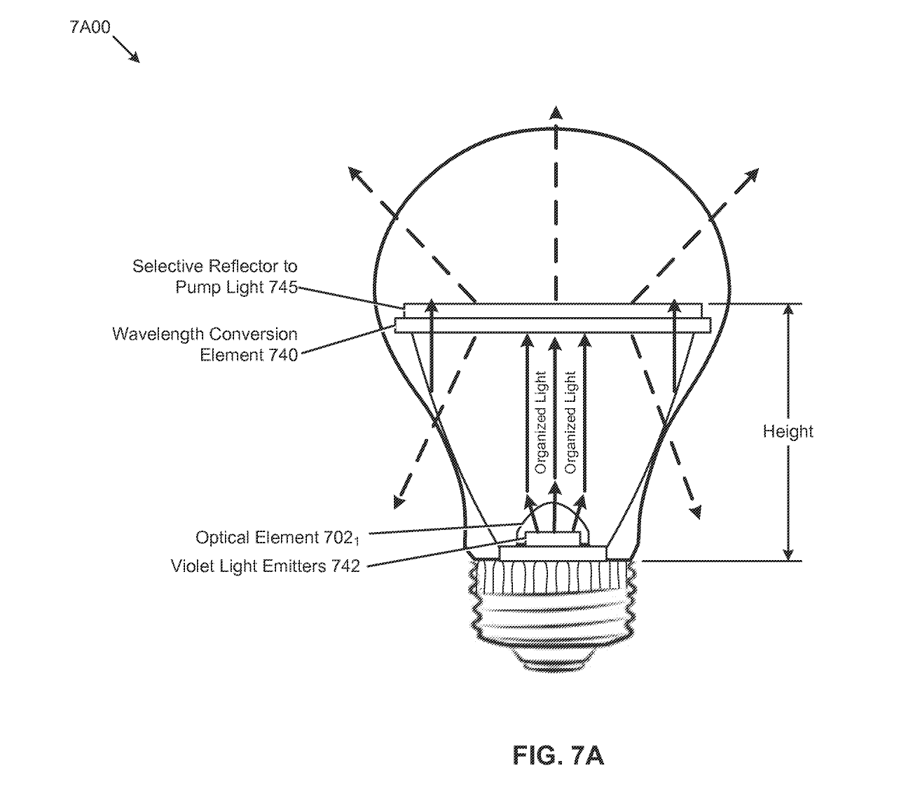

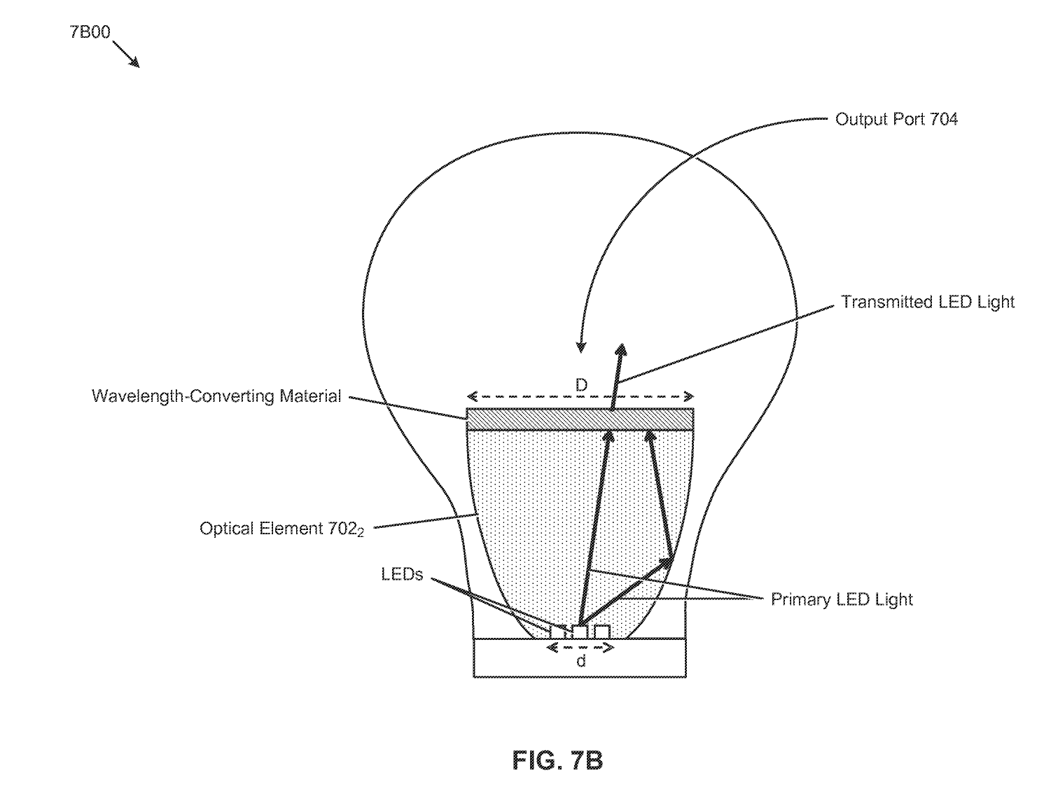

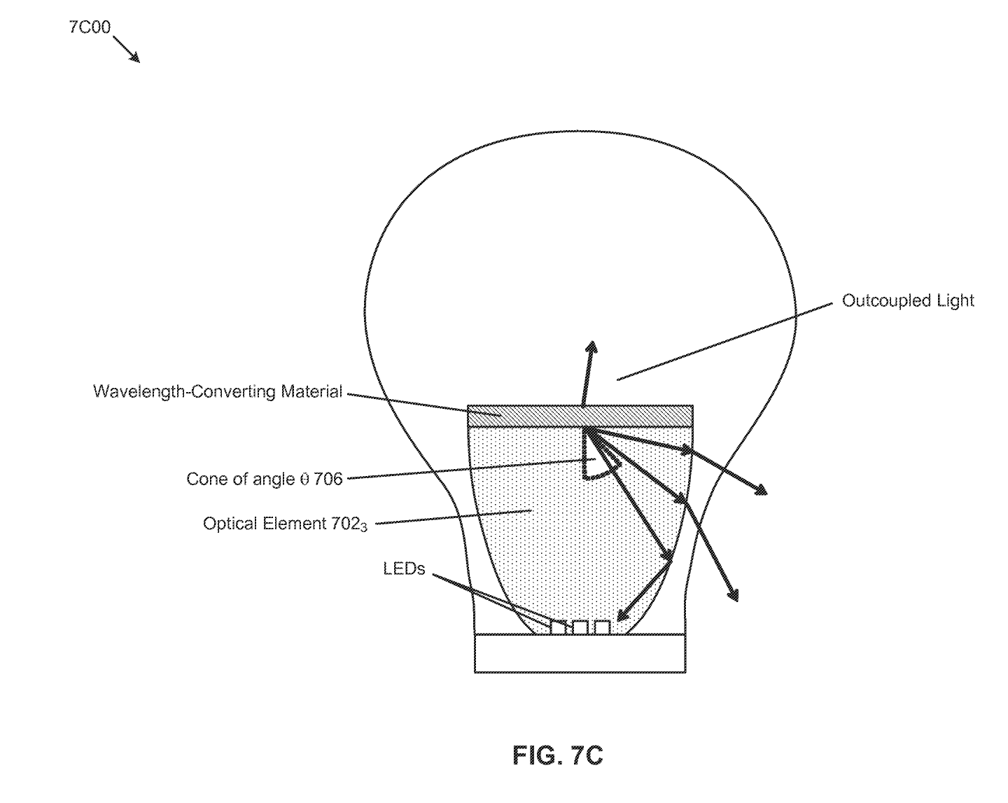

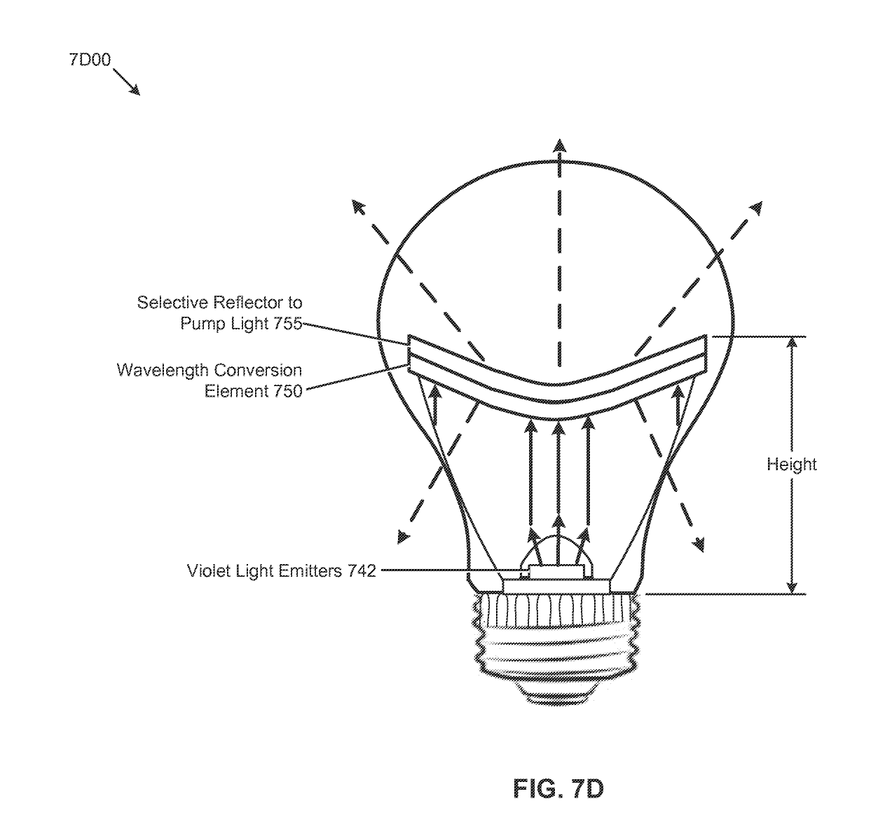

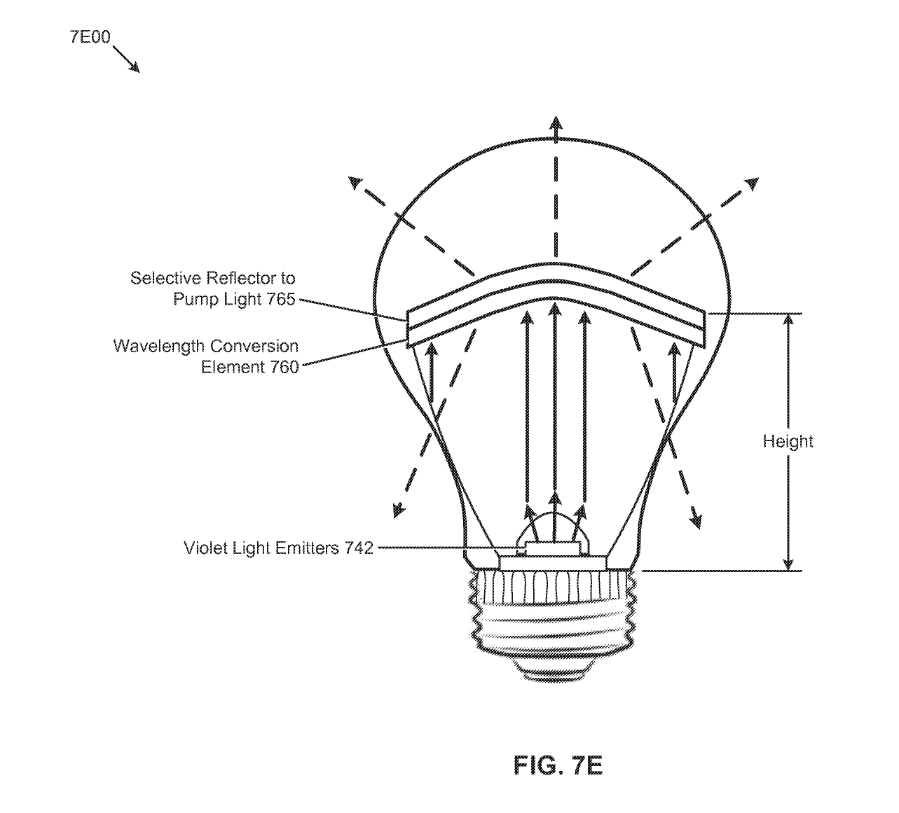

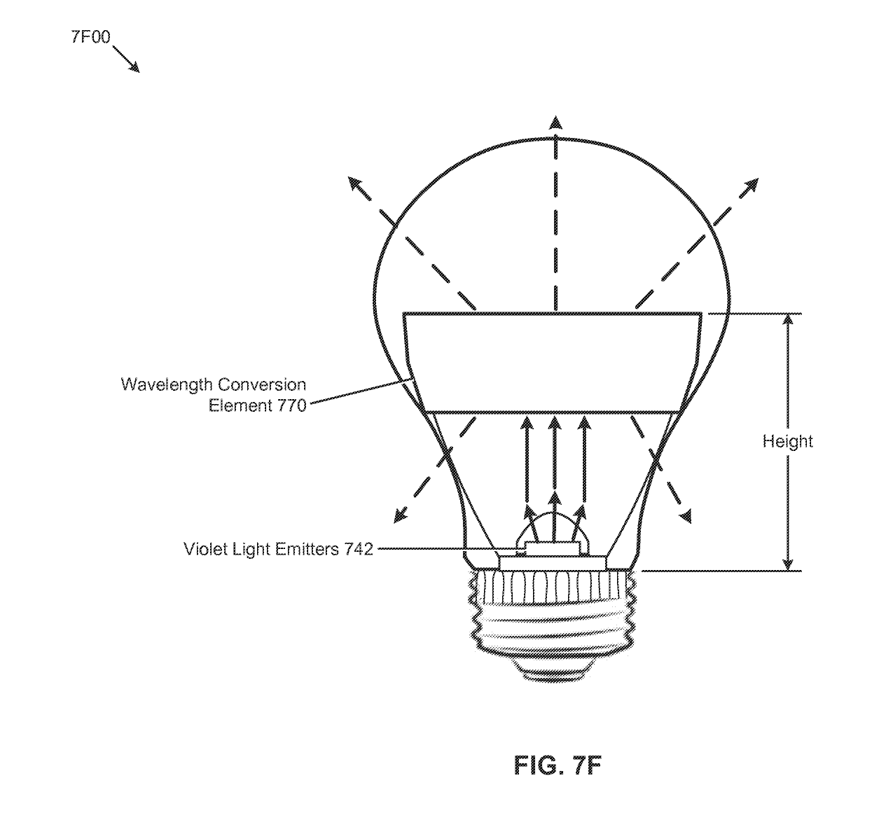

One embodiment comprises an “A lamp” configuration having violet-emitting pump LEDs that are coupled to a total-internal-reflection (TIR) lens to redirect the LED pump light to generate a substantially vertical emission in a narrow angular cone of less than ±20 degrees (refer to FIG. 7C). Design of such optics (TIR lens or other designs, such as prismatic lenses for instance) is known in the art. The resulting angular cone of collimation by the optic may for instance be 5°, 10°, 20°, 35°, etc. Wavelength conversion material is deposited on the end of the TIR lens such that almost all of the pump light (>90%) is absorbed by the conversion material. Light emitted by the conversion material is directed in a Lambertian manner perpendicular to the plane of the conversion material. This is the case of both upward and downward emission, which can be controlled by the conversion material thickness and/or by controlling the doping level. If balancing between the upward versus downward emission light results in too much primary light leakage out of the top surface of the conversion material, a wavelength selective reflector may be placed above the conversion material. In many A-lamp applications, the target light distribution should be weighted approximately equal for upward versus downward light, and with similar (and low, less than 10%) residual primary pump light.

In the case of FIG. 7A, about ⅔ of the converted light is emitted downward with a Lambertian pattern (due to the refractive index of refraction of the optic, about 1.5, compared to the refractive index of air). In other configurations, an air gap may be formed under the wavelength converting material and this ratio may be on the order of ½.

FIG. 7A, FIG. 7B, FIG. 7C, FIG. 7D, FIG. 7E and FIG. 7F show various embodiments with variations over certain design elements. Strictly as examples, the cause and effect of different trajectories of various light rays emitted by the LED are shown and discussed.

FIG. 7A features an optical element 702₁. The optical element surrounds the LEDs and is designed to redirect a large fraction of the pump light towards the output port 704 (see FIG. 7B). This optical element may be a TIR lens design (for instance, a parabolic reflector or other) formed in a transparent material with an refractive index of about 1.4 to 1.6. The material may for instance be a glass or a plastic (including polycarbonate or others). Wavelength-converting material is disposed on or within structures comprising the output port.

FIG. 7B features an optical element 702₂ configured such that at least 80% (or at least 90%, at least 95%) of the pump light emitted by the LEDs reaches the output port 704. The wavelength-converting material is formed on structures comprising the output port. The optical element may be characterized by a half-angle of emission θ, whereby the majority of the light emitted by the LEDs is directed to the output port with angles of incidence lower than θ. For instance, θ may be 5°, 10, 20, 30°. In general, θ is related to the lateral size (d) of the area supporting the LEDs and to the lateral size (D) of the output port of the optical element. For an etendue-conserving optical system, this relationship is typically d=D·sin(θ). It is possible to make the value of θ smaller than a desired value by using an LED source and an optical element with proper dimensions.

FIG. 7C details the trajectories of various converted light rays emitted by the wavelength-converting material. Some of the light is emitted upward and is outcoupled. Some of the light is emitted downward. However, only a small fraction of this light is re-directed towards the LED area—namely, mostly rays whose angles are smaller than the angle θ (due to reciprocity of optics). Rays falling outside the cone of angle θ 706, on the other hand, will not be redirected back to the LEDs; rather, they will escape the optical element after one or several bounces. Therefore, the embodiment improves upon typical designs since only a small fraction of the light emitted downward is optically coupled to the lossy LEDs. This small fraction is governed by the relative solid angle swept by θ. For instance, if θ=20° and if the converted light has a Lambertian emission diagram, about 12% of the downward light falls within this solid angle and is optically coupled to the LEDs. Since about ⅔ of the total converted light is emitted downward, the net fraction of converted light directed towards the LEDs is F2=⅔×12%=8%. This stands in contrast to certain designs such as that of FIG. 6, where the fraction F2 of downward light optically coupled to the LEDs is a large fraction (e.g., on the order of F2=50% to 70%, as discussed). Other values of θ yield other values of F2; for instance θ=10° corresponds to F2=2%; θ=30° corresponds to F2=17%.

On the other hand, the fraction F1 of pump light reaching the wavelength converting material is high, for instance 90%. Therefore the fraction F2/F1 is small—from 0.02 to 0.2 for the various values of θ discussed above. This stands in contrast to typical remote-phosphor systems, where the ratio F2/F1 is larger and on the order of unity as discussed previously.

It should be appreciated that these embodiments can be achieved with a variety of optical designs. Indeed the arguments used here are based on a few general principles: pump light reaches the conversion material within a narrow range of directions; converted light is emitted randomly (for instance with a Lambertian pattern); due to reciprocity the converted light emitted within the narrow range of directions is sent back towards the pump LEDs but the rest of the converted light is not. Designing optics which organize pump light in a desired angular range is known in the art and can be achieved by various designs and techniques.

The small fraction of converted light directed downward contributes to a high package efficiency. If we assume, as for FIG. 6, that F2=8%, that the LEDs and surrounding surfaces have a reflectivity of 90% and that downward light bounces twice off these surfaces before escaping, the package efficiency is PE=92%+8%×0.9×0.9=98%. This number stands in contrast to the lower value (about 87%) discussed in the case of FIG. 6. The PE value for certain system configurations may be slightly lower than this high value due to secondary effects (such as partial Fresnel reflections); however the beneficial effects of the described embodiments is manifest.

Selected embodiments described herein differ from legacy remote-phosphor systems at least in that they break the symmetry between coupling LED light to the converting material and coupling converted light back to the LEDs. This is possible because the LED light reaches the converting material at specific angles, but the converted light is emitted at a variety of angles—most of which do not couple optically to the LEDs due to reciprocity.

As earlier discussed, the embodiment of FIG. 7A produces upward/downward Lambertian emission, which might not match a desired A-lamp distribution (e.g., near isotropic emission). In other embodiments, the wavelength converting material element 740 and a selective reflector 745 is disposed vis-à-vis the violet light emitters 742 (and vis-à-vis optical element 702₃) to form specific shapes, which shapes serve to increase the amount of sidelight and achieve a more isotropic emission. For example, the conversion material may be on a shaped concave surface (e.g., see FIG. 7D) or on a shaped convex surface (e.g., see FIG. 7E). The curvature of the shape is tuned to match the final light distribution. In another embodiment, the conversion material is placed on the sides of the TIR lens as well as the top to increase the amount of side light (see FIG. 7F). The amount of side light can be tuned by selection of the height of side surface covered by the conversion material.

An example of a beam pattern obtained by a TIR collimating optic is shown on FIG. 7G. FIG. 7G-A shows a sketch of a prismatic TIR lens. FIG. 7G-B shows experimental beam patterns corresponding to implementations of lenses: a 9° beam produce by the optic of FIG. 7G-A, and a 25° beam produced by a conventional TIR lens.

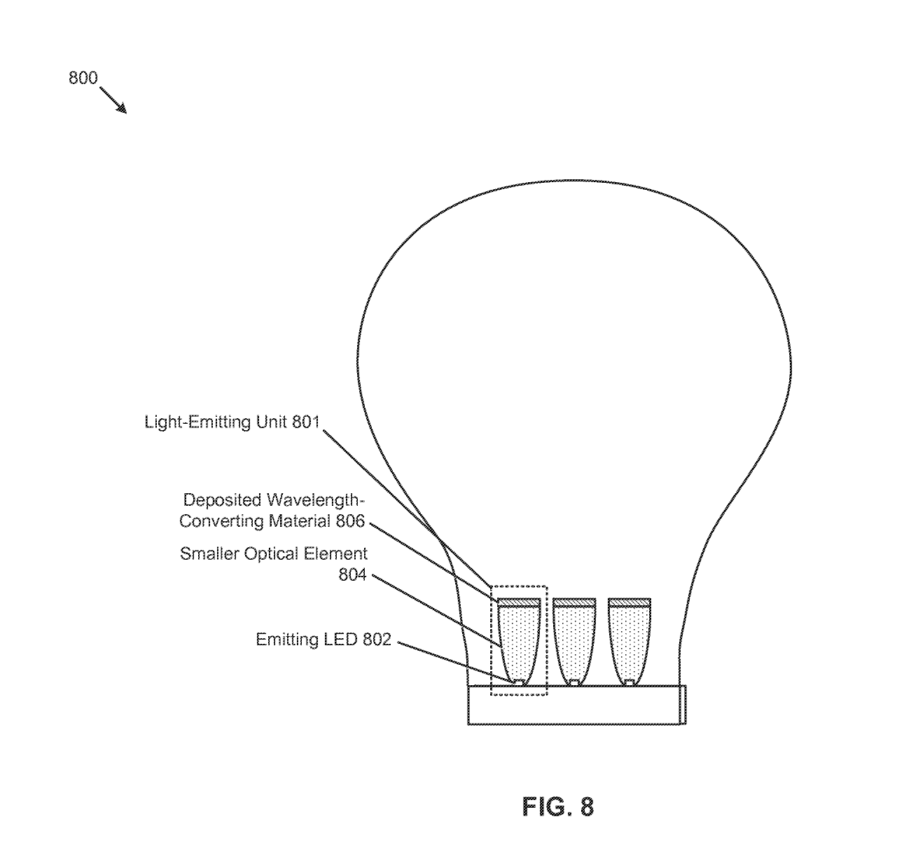

FIG. 8 shows such an embodiment wherein the LED area and the optical element are configured to provide good coupling from LED light to the converting material while at the same time, and limited coupling from converted light to the LEDs.

Rather than forming a relatively large optical element surrounding multiple LEDs, several relatively smaller optical elements are formed. Each of such relatively smaller optical elements are formed and positioned to surround only one LED. The light-emitting unit 801 formed by the emitting LED 802, the smaller optical element 804 and the deposited wavelength converting material 806 is replicated in multiple instances, as shown. Such configurations offer advantages over the embodiment of FIG. 7A, including reduced consumption of materials (e.g., wavelength-converting materials) and better thermal dissipation.

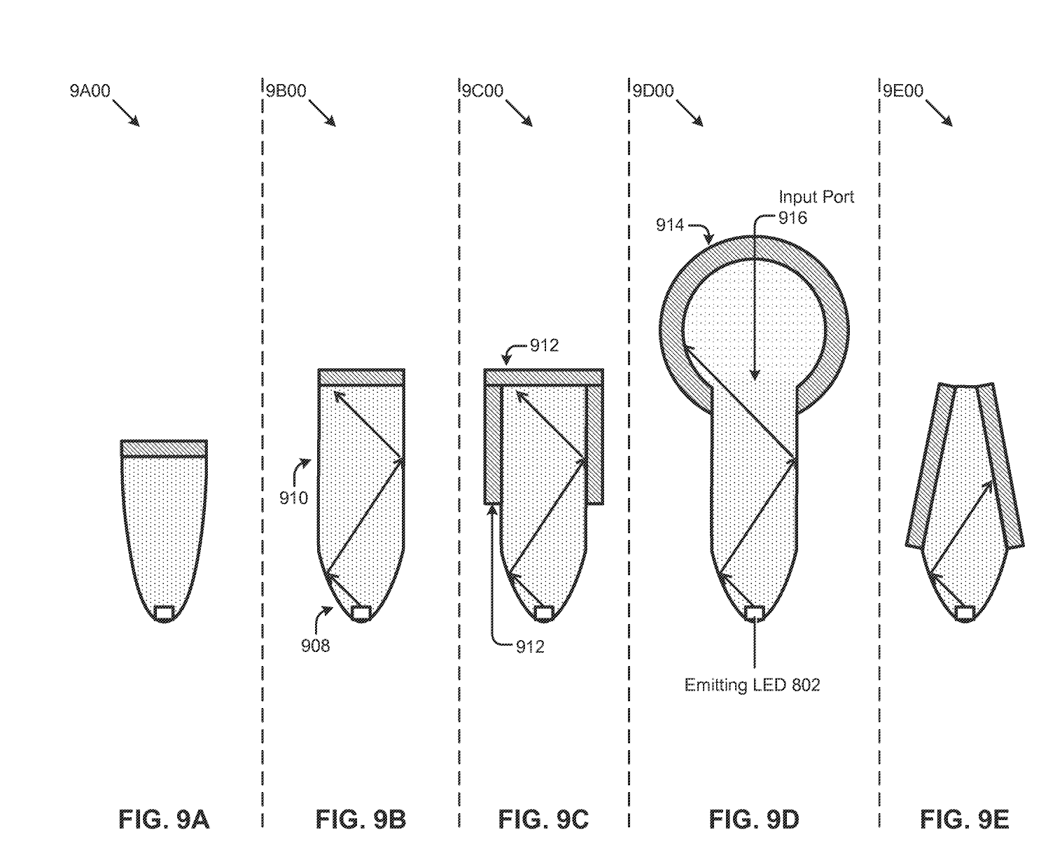

FIG. 9A, FIG. 9B, FIG. 9C, FIG. 9D and FIG. 9E show various designs of optical elements and converting materials.

FIG. 9A shows an element 9A00 similar to that of light-emitting unit 801. FIG. 9B shows an elongated optical element 9B00. The curved section 908 provides steering of the LED light (this may be a parabolic reflector or another design), followed by a straight section 910 acting as a waveguide for the LED light, and finally an output facet with conversion material.

FIG. 9C shows the converting material 912 is also formed over the sidewalls of the optical element 9C00. In such cases, the LED light can be efficiently absorbed and converted by the sidewall material. Only a small fraction of the converted light is coupled back into the LED since little converted light is emitted at angles that are guided by the optical element.

FIG. 9D shows an embodiment where the optical element 9D00 is terminated by a larger volume (here, shaped as a sphere 914 coated with converting material). In the case of FIG. 9D all the LED light entering the sphere is coupled to the converting material, but only a small fraction of the converted light is likely to interact with the input port 916 of the larger volume and then be coupled back into the emitting LED 802.

FIG. 9E shows sidewalls of the optical element 9E00 that are wedged.

Some embodiments such as are shown and discussed as pertaining to FIG. 9A through FIG. 9E may be enabled by the use of relatively small LEDs. The size of the optical element scales with that of the relatively small LED. For example, the relatively small LED may have a lateral dimension of about 0.25 mm, or a base area of about 0.06 mm². This may enable optical elements with a lateral diameter of about 1 mm (or 0.5 mm, or 2 mm) depending on the desired distribution of angles of the LED light in the optical element. This stands in contrast to conventional LEDs that have a lateral dimension of 1 mm, and which, at that dimension, may require optical elements with a lateral size of about 3 mm or more.

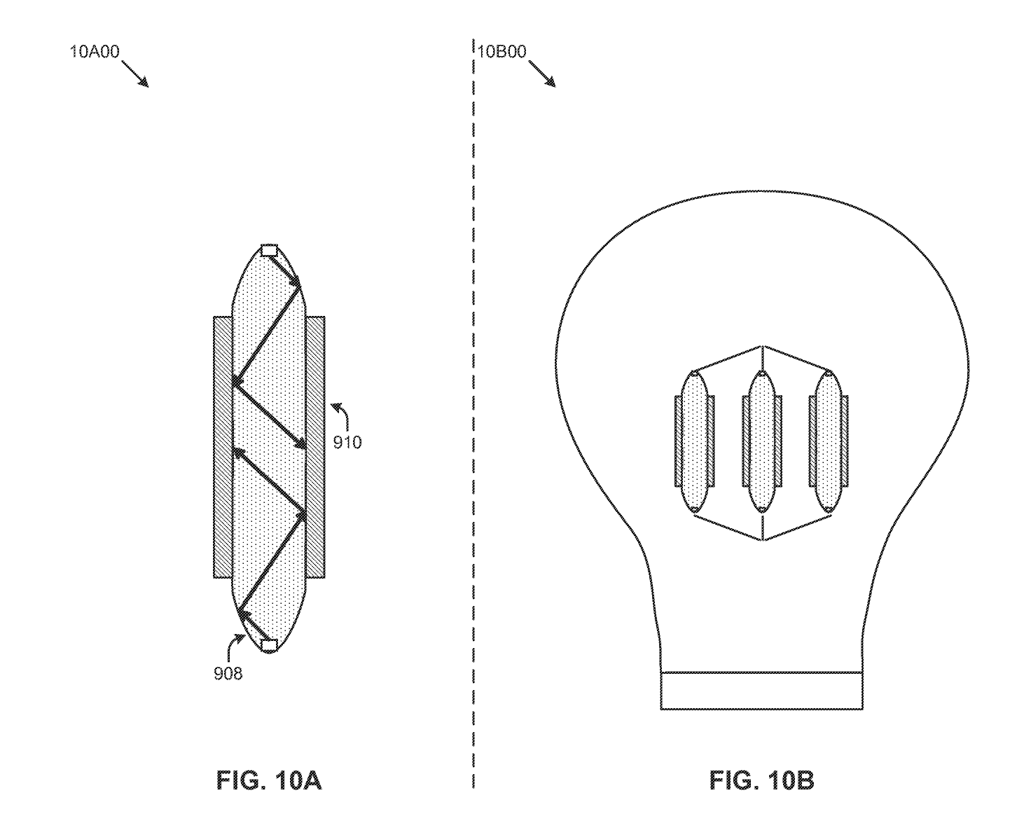

FIG. 10A shows an embodiment with a curved section 908 and a straight section 910 (e.g., similar to that of FIG. 9C), with an LED at each end of the waveguide. Such embodiments can be placed into a lamp 10B00.

As depicted in FIG. 10B, when the diameter of the optical elements are small, they may appear to a human viewer as filaments (e.g., as in an “Edison Bulb”). The optical element sidewalls may be coated with wavelength-converting material and may be configured to light up uniformly, thus appearing as a filament as were used in formerly ubiquitous filament lamps based on the “Edison Bulb”. In addition, the LEDs are placed at the ends of the optical elements and may therefore be efficiently heatsunk. This stands in contrast to common implementations of LED filament-like lamps, where the LEDs are placed on the pseudo-filament and have limited heatsinking Combinations of the shown embodiments may be integrated to a lamp of various shapes so as to emulate the appearance of a filament lamp.

Although the shown embodiments have one or two LEDs coupled to the optical element, other embodiments can include several or more LEDs. Also, the wavelength-converting material can be selected, formed, and deposited according to various methods. For instance, wavelength-converting material may be sprayed onto a surface. Or, the wavelength-converting material may comprise a mix of phosphors and silicone which is dispensed and cured. Or, the wavelength-converting material may embedded in a dry film (for instance, composed of one or more phosphors carried in a film) which is applied to an optical surface. The thin film may be applied conformally to a curved surface, or to one or more of several surfaces, or the thin film may be dip-coated to deposit wavelength-converting materials onto optical surfaces.

In various embodiments of the invention, at least some of the pump LEDs are violet LEDs. For instance, the violet LEDs may emit in the wavelength range 400 nm to 430 nm. This may be advantageous for several reasons. First, the presence of violet light in the emitted spectrum may contribute to the quality of the light by increasing the color fidelity (as measured by a fidelity metric such as CRI or IES Rf), and/or by improving the color gamut (as measured by a gamut metric like GAI or IES Rg), and/or by improving the whiteness rendering (for instance, providing an excitation of a fluorescent whitening agent which is at least 20% or 50% of the excitation provided by a blackbody with the same CCT). Further aspects and further beneficial impacts of use of violet light-emitting LEDs on the quality of light and general approaches to achieving quality of light are described in U.S. Pat. No. 8,933,644, which is incorporated by reference in its entirety.

Second, violet pump LEDs can provide very high efficiency beyond the limit observed in conventional blue-pumped devices. This may especially be the case if a bulk GaN substrate is employed. Such performance is described in U.S. application Ser. No. 14/615,315 filed on Feb. 5, 2015, which is hereby incorporated by reference in its entirety. Some embodiments include at least one LED grown on a bulk GaN substrate, emitting in a wavelength range 400-430 nm, and having a wall-plug efficiency (into an encapsulated medium) of at least 50% (or 60%, or 70%) at a current density of 100 Amps per cm² and at a junction temperature of 85° C.

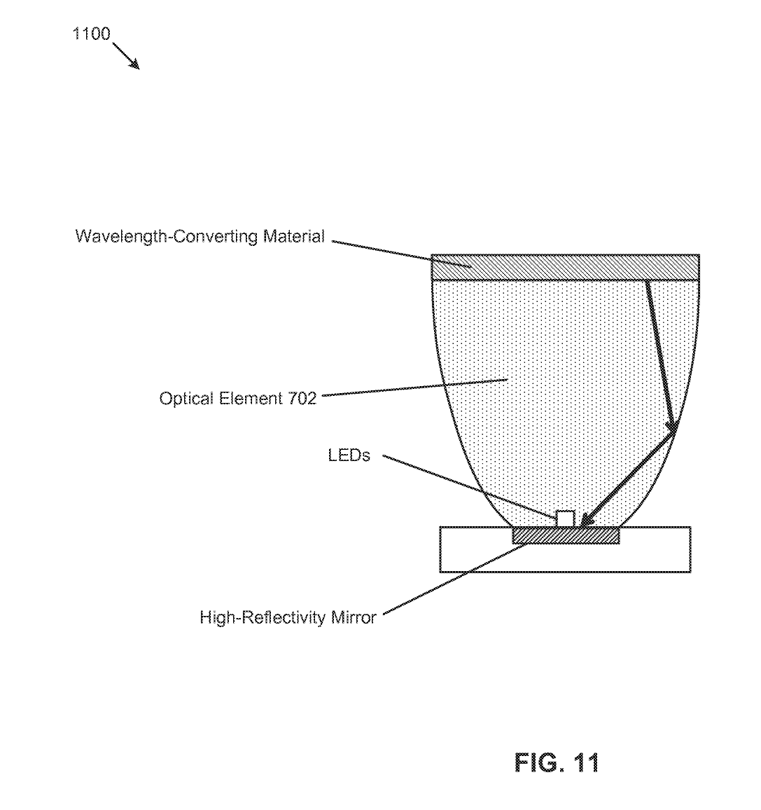

In some embodiments, such as the mirror embodiment 1100 depicted in FIG. 11, optical loss is further mitigated by using LEDs with a high reflectivity and placing them on a mounting member that has a reflective surface. In such embodiments, the converted light directed backwards towards the LEDs incurs only a small amount of loss. For instance, the LED may have a reflectivity higher than a desired value (such as 80%, 80%, 95%, 98%) at a given wavelength (such as 500 nm, 600 nm) or a wavelength range (such as 450 nm to 700 nm) and at a given angle of incidence (such as 0°) or angle range (such as 0°-90°.

Embodiments of the invention can be integrated into various lamps, for instance, and without limitation, A-lamps, BR lamps and other non-directional lamps.

Embodiments of the invention may include a cover (for instance, similar in shape to the glazing of an A-lamp). This cover may be made of glass, plastic or another material. A cover may be clear, frosted, or colored.

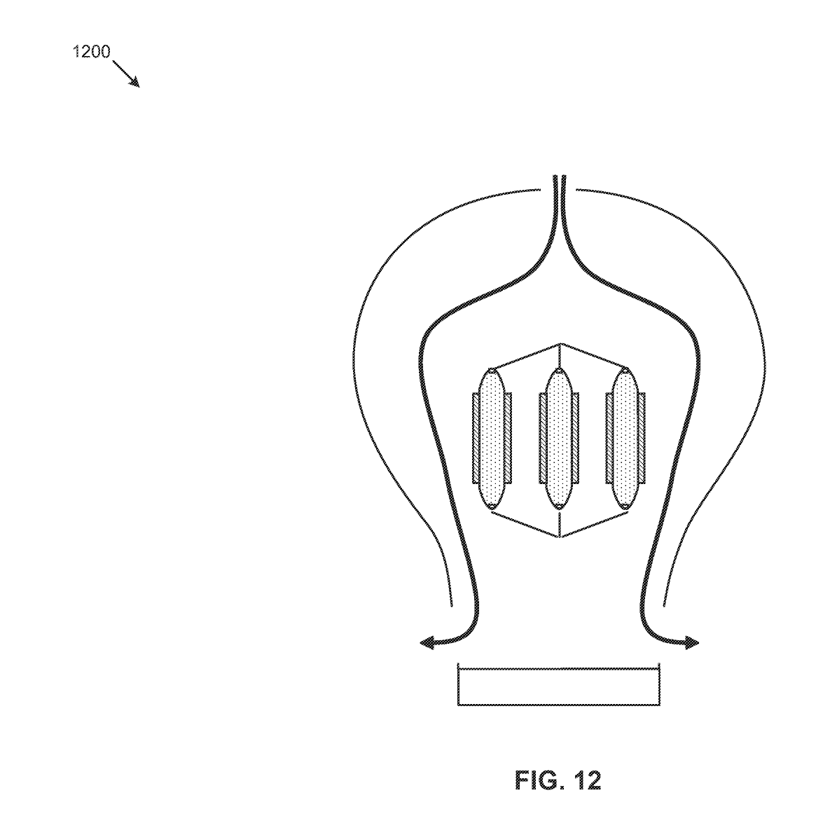

In some embodiments such as the air flow embodiment 1200 of FIG. 12, air flow is enabled through the lamp by forming openings in the lamp. The airflow serves to cool down the wavelength-converting material.

In some embodiments, light from the pump LEDs is converted by more than one mix of converting materials. For instance, a first set of pump LEDs is converted by a first phosphor mix to produce a first spectrum and a second set of pump LEDs is converted by a second phosphor mix to produce a second spectrum. The two sets of LEDs may for instance be inserted into two different optical elements, each element being coated with a different phosphor mix. The two spectra may differ in their properties: they may have a different CCT, a different chromaticity, different color rendition properties and other properties pertaining to quality of light. The two sets of pump LEDs may be driven independently, so that embodiments of the invention may emit a spectrum which is the first spectrum the second spectrum or a combination therefor depending on the drive conditions. This may result in a lighting system with high efficiency (thanks to the efficient remote-phosphor architecture) and a tunable spectrum.

Further aspects of, and further beneficial impacts of use of pump LEDs and general approaches to achieving a tunable spectrum are described in U.S. application Ser. No. 14/316,685 filed Jun. 26, 2014, which is incorporated by reference in its entirety.

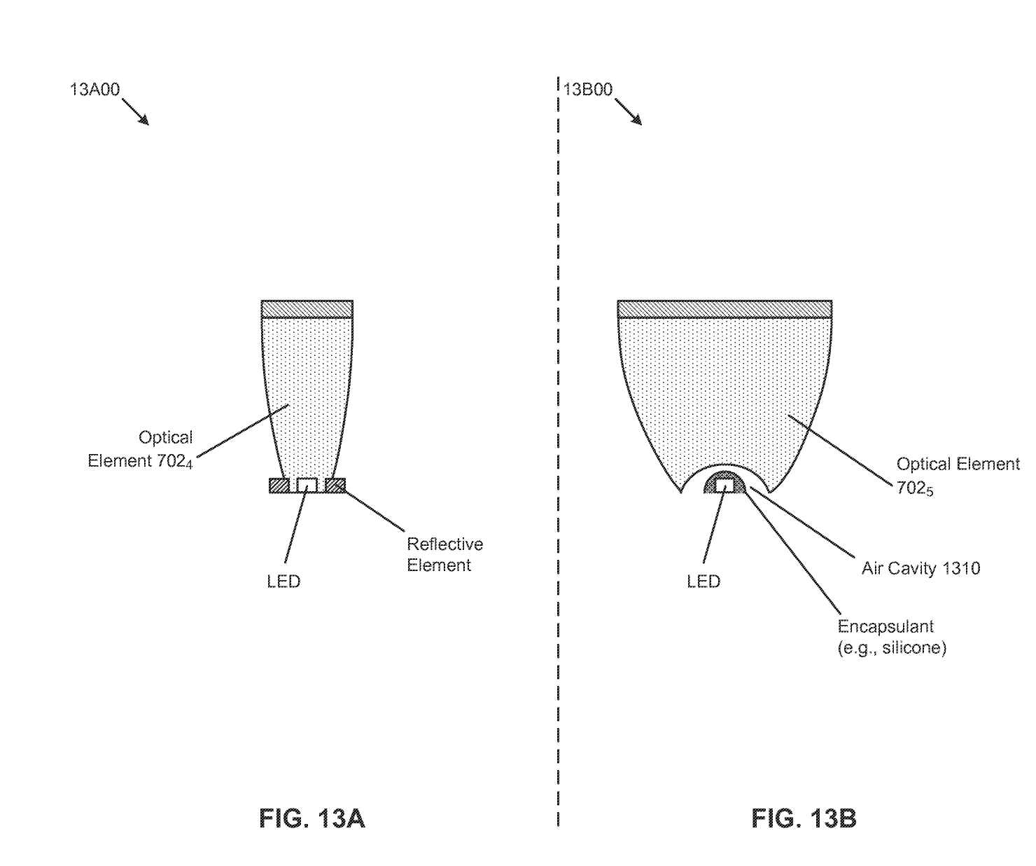

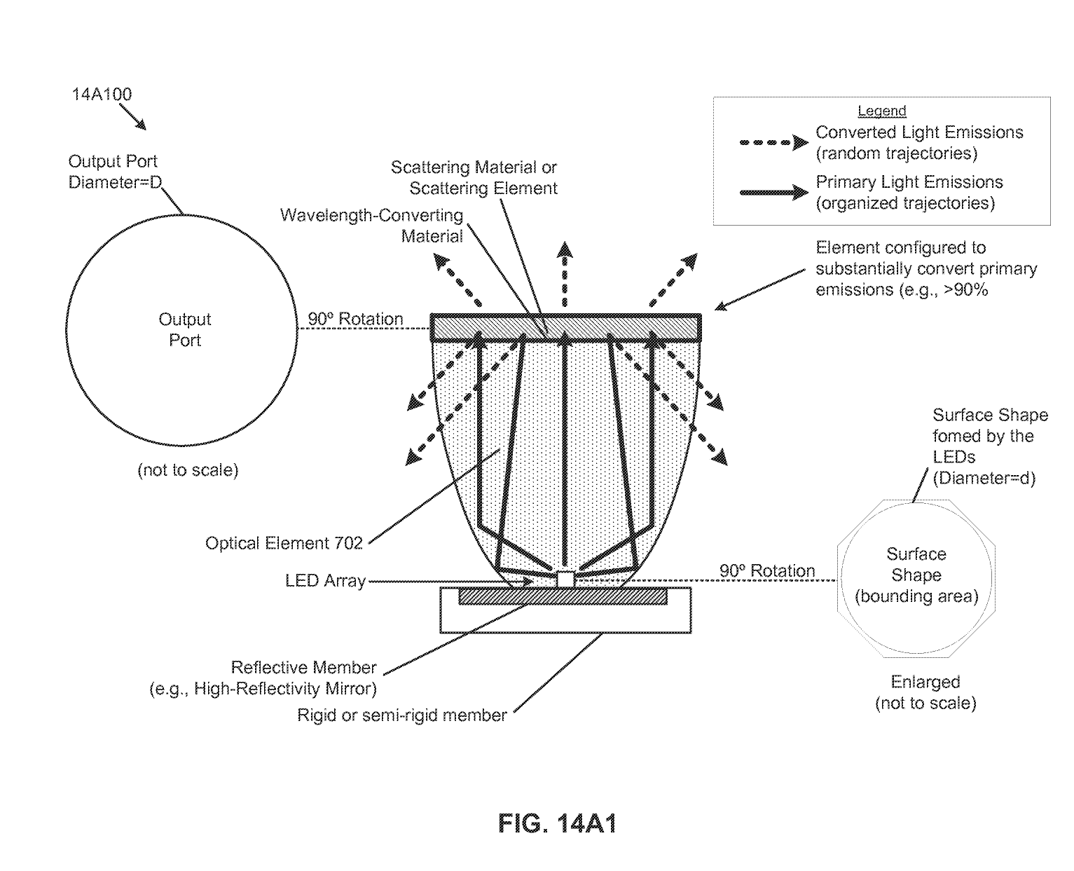

FIG. 13A and FIG. 13B illustrate additional embodiments where the optical environment around the LED is varied. In FIG. 13A, the reflective element unit 13A00 has reflective elements that are placed on the sides of the LED. The optical element 702₄ is placed above the reflective elements. More generally, the optical element may incorporate one or several reflective elements (which may be specular or diffuse reflectors).

FIG. 13B shows a design 13B00 of an optical element where the LED is encapsulated (e.g., with silicone) and the LED is placed within or in proximity to an optical element having an air cavity 1310. The cavity can be bounded by as a freeform surface (e.g., in the design of the optical element) in order to better control the path of light emitted by the LED. In particular, the surface of the cavity and the presence of the air cavity interface serves to increase the likelihood of light to be organized by the internal reflection characteristics of the optical element 702₅. In some embodiments, this is characterized by a range of directions of pump light directed by the optical element, or by a cone angle of the beam of pump light directed by the optical element.

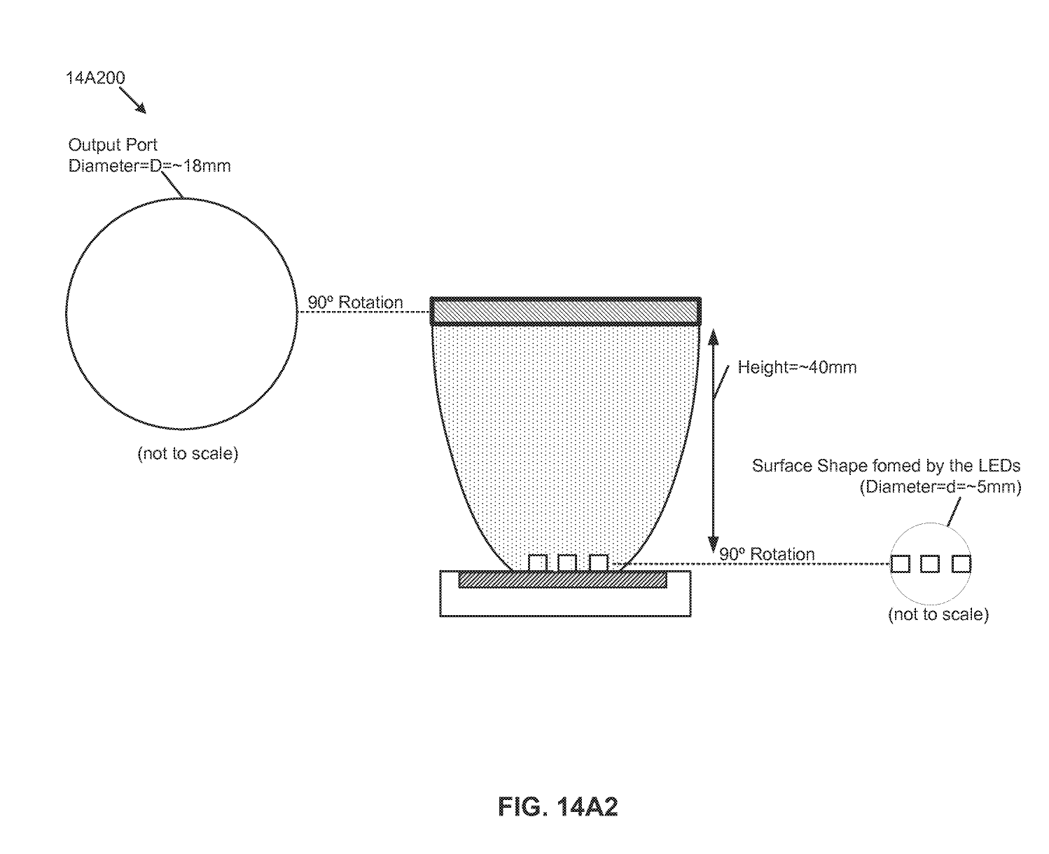

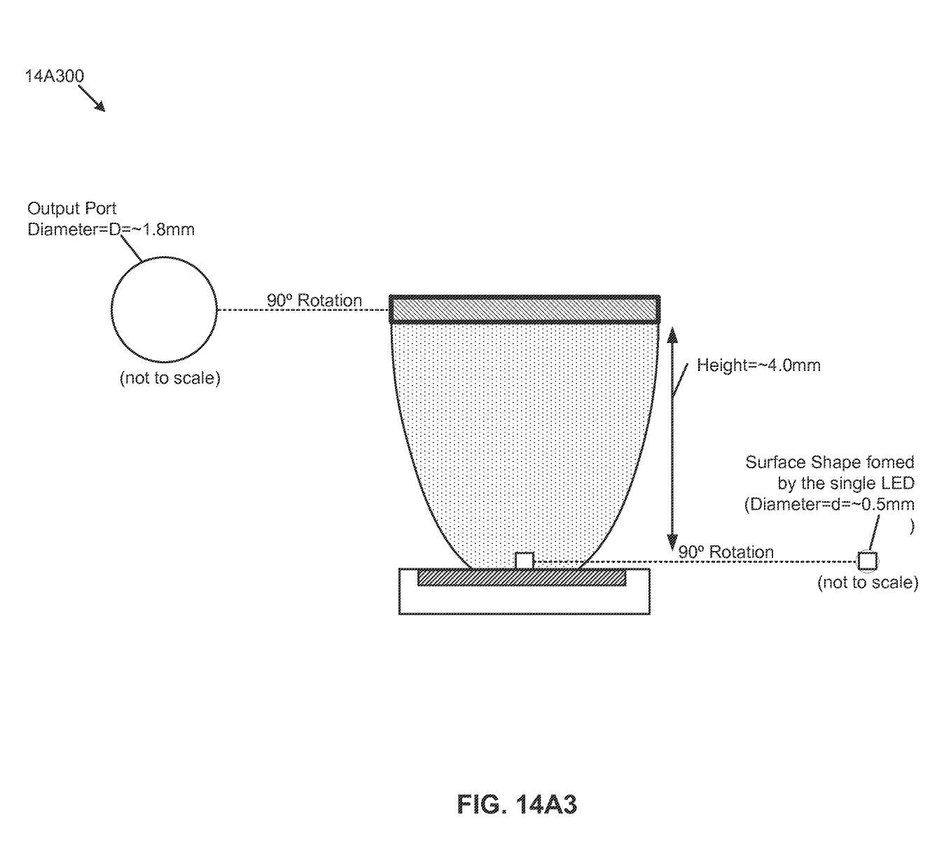

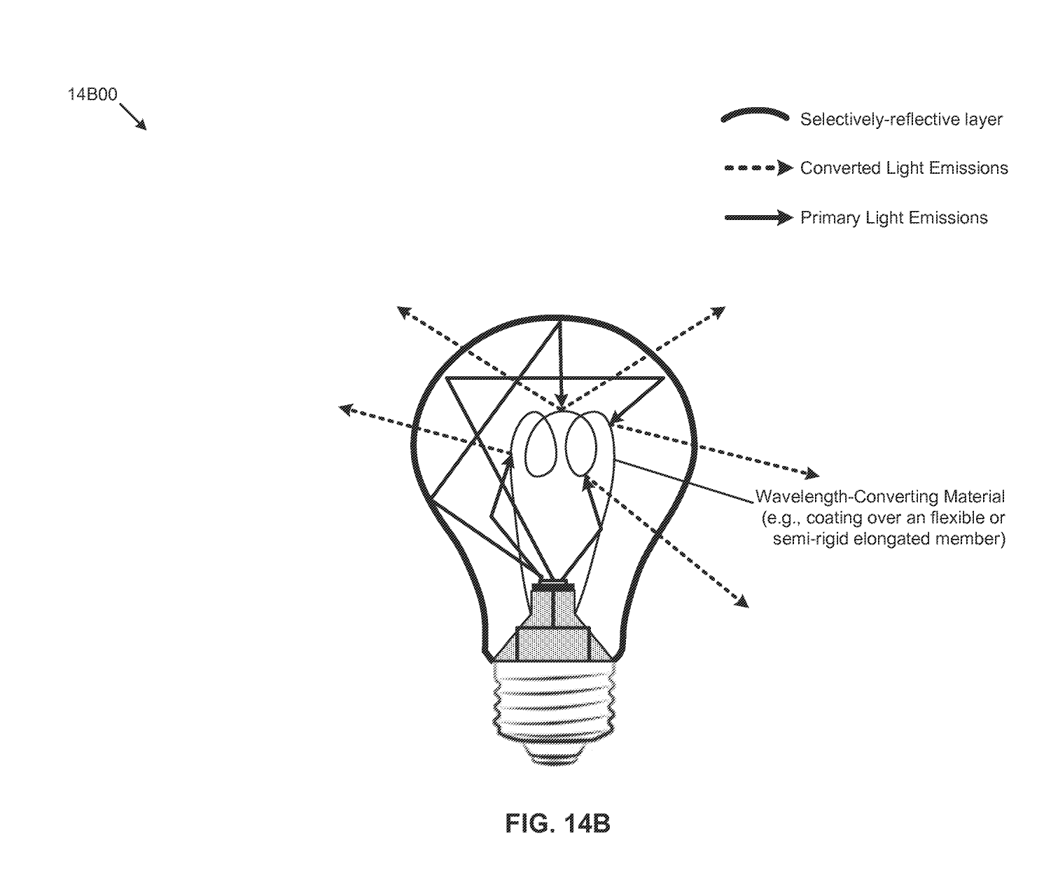

FIG. 14A depicts a light conversion process 14A100 involving interrogation of a scattering wavelength-converting member by organized light. As shown, the wavelength-converting material is formed on structures comprising the output port. Further, the optical element is characterized by a half-angle of emission, whereby the majority of the light emitted by the LED array is directed to the output port with angles of incidence lower than the half-angle of emission. As shown, the half-angle of emission is related to the lateral size of the area of the surface shape bounding the LEDs (diameter=d) with respect to the of the output port diameter (diameter=D). A surface shape can be defined as the convex hull formed by the shape of the LED, or the convex hull formed by the shape of a group of LEDs.

FIG. 14A2 depicts a light conversion processes 14A200 involving interrogation of a scattering wavelength-converting member by organized light through a compound parabolic concentrator having a surface shape that bounds an array of LEDs (e.g., see the three LEDs within the bounding area of the surface shape).

FIG. 14A3 depicts a light conversion processes 14A300 involving interrogation of a scattering wavelength-converting member by organized light through a compound parabolic concentrator having a surface shape that bounds an single LED (e.g., see the single LED within the bounding area of the surface shape).

The shown dimensions for the lateral size of the area of the surface shape bounding the LED or LEDs (diameter=d) with respect to the of the output port diameter (diameter r=D) are merely examples, and other examples are possible. Table 5 presents some variations.

TABLE 5
Variations

| | | Numeric | Numeric | Numeric | Numeric |
|---|---|---|---|---|---|
| Variable | | Example | Example | Example | Example |
| Angle θ | (degrees) | 25 | 25 | 45 | 45 |
| Diameter d | (mm) | 5 | 0.5 | 5 | 0.5 |
| Diameter D | (mm) | 18 | 1.8 | 11 | 1.1 |
| Height h | (mm) | 40 | 4 | 15 | 1.5 |

FIG. 14B depicts a light conversion process 14B00 involving interrogation of a phosphor-coated filament-like member and a selectively-reflective layer.

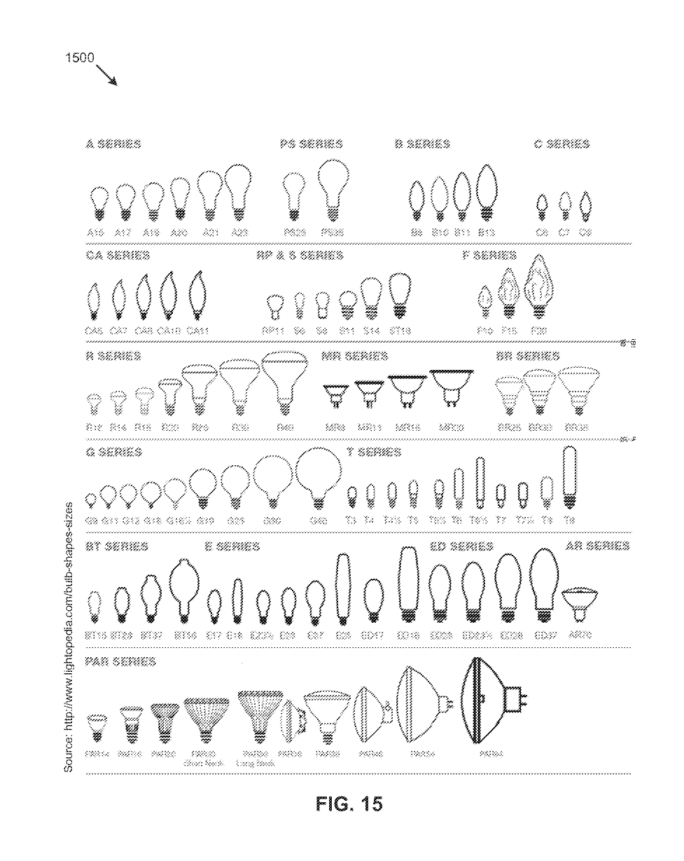

FIG. 15 presents a selection of lamp shapes 1500 corresponding to known-in-the-art standards. The aforementioned lamps are merely selected embodiments of lamps that conform to fit with any one or more of a set of mechanical and electrical standards, which in turn can be configured to emit a configurable shade. At least some of a range of shades throughout the black body loci are tunable by the relative measures of colors (e.g., red, green/yellow, blue). In the disclosed embodiments of LED lamps, color tuning to achieve a particular (e.g., desired) white shade of the LED lamp under conditions of ambient lighting can be accomplished by selecting the relative amounts of wavelength-emitting materials. Similarly, when those relative amounts of wavelength-emitting materials are excited by the light source 142, the aggregate LED lamp emission corresponds to a particular (e.g., desired) white light color, such as depicted by the warm white lamp emission spectrum (as shown).

As one specific example, an LED lamp can be configured to achieve a particular white shade by selecting a first amount p of first wavelength converting material (e.g., a blue phosphor) and selecting a second amount q of second wavelength converting material (e.g., a yellow phosphor). In certain cases, a third wavelength converting material (e.g., a red phosphor) can be mixed in to achieve a desired tunable (e.g., white) shade. The amounts p and q are selected to achieve (1) the desired (e.g., cool white) shade of the LED lamp under ambient light conditions, and (2) the desired LED lamp emission spectrum when the LED lamp is in operation (e.g., when the light source is on and its emission is combined with the remote phosphor emission).

In certain embodiments, various patterns and/or arrangements for different radiation sources (e.g., LEDs) can be used. The above description and illustrations should not be taken as limiting the scope of the present disclosure.

What is claimed is:

1. An LED lighting system comprising:
one or more LEDs disposed on a mounting member,
wherein the one or more LEDs emitting a pump light, and
wherein the one or more LEDs have respective base areas, and
wherein a sum of the base areas cover a first area; and
an optical element optically coupled to the pump light,
wherein at least one region of the optical element comprises wavelength-conversion material covering a second area, and
wherein the wavelength-conversion material emits converted light upon excitation by the pump light, and
wherein the optical element is formed using a non-opaque material that is transparent to the pump light and the converted light, and
wherein the optical element has a material composition, shape, and dimensions to direct at least 80% of the pump light upon the wavelength-conversion material by total internal reflection and to direct at most 25% of the converted light upon the LEDs, and
wherein the second area is at least four times greater than the first area.

2. The LED lighting system of claim 1, wherein the wavelength-conversion material at least a height h away from the first area, the height h being 0.5 mm.

3. The LED lighting system of claim 1, wherein the wavelength-conversion material at least a height h away from the first area, the height h being 40 mm.

4. The LED lighting system of claim 1, wherein the optical element is at least one of, a compound parabolic concentrator, a total internal reflection lens, and a prismatic lens.

5. The LED lighting system of claim 4, wherein the non-opaque material is comprised of at least one of, a glass-containing material, and a plastic-containing material.

6. The LED lighting system of claim 1, wherein the optical element is in the form of at least one of, an encapsulating optical element, an elongated optical element, and an optical element having wedged sidewalls.

7. The LED lighting system of claim 1, wherein at least a portion of the wavelength-converting material is formed over or within proximity of at least a portion of one or more surfaces of the optical element.

8. The LED lighting system of claim 1, wherein at least a portion of the wavelength-converting material is disposed on or within structures comprising an output port.

9. The LED lighting system of claim 1, wherein the pump light is characterized by a peak wavelength in a first range from about 380 nm to about 435 nm.

10. The LED lighting system of claim 1, further comprising an encapsulating material overlaying at least some of the one or more LEDs, the encapsulating material comprising a material selected from silicone, epoxy, and a combination thereof.

11. An LED lighting system having a package efficiency, the LED lighting system comprising:
one or more LEDs disposed on a mounting member,
wherein the one or more LEDs emitting a pump light, and
wherein the one or more LEDs have respective base areas, and
wherein a sum of the base areas cover a first area; and
an optical element optically coupled to the pump light,
wherein at least one region of the optical element comprises wavelength-conversion material covering a second area, and
wherein the wavelength-conversion material emits converted light upon excitation by the pump light, and
wherein the optical element is formed using a non-opaque material that is transparent to the pump light and the converted light, and
wherein the optical element has a material composition, shape, and dimensions to direct at least 80% of the pump light upon the wavelength-conversion material by total internal reflection and to direct at most 25% of the converted light upon the LEDs, and
wherein the second area is at least four times greater than the first area; and wherein the package efficiency is at least 90%.

12. The LED lighting system of claim 11, wherein the wavelength-conversion material at least a height h away from the first area, the height h being 0.5 mm.

13. The LED lighting system of claim 11, wherein the wavelength-conversion material at least a height h away from the first area, the height h being 40 mm.

14. The LED lighting system of claim 11, wherein the optical element is at least one of, a compound parabolic concentrator, a total internal reflection lens, and a prismatic lens.

15. The LED lighting system of claim 14, wherein the non-opaque material is comprised of at least one of, a glass-containing material, and a plastic-containing material.

16. The LED lighting system of claim 11, wherein the optical element is in the form of at least one of, an encapsulating optical element, an elongated optical element, and an optical element having wedged sidewalls.

17. The LED lighting system of claim 11, wherein at least a portion of the wavelength-converting material is formed over or within proximity of at least a portion of one or more surfaces of the optical element.

18. The LED lighting system of claim 11, wherein at least a portion of the wavelength-converting material is disposed on or within structures comprising an output port.

19. The LED lighting system of claim 11, wherein the pump light is characterized by a peak wavelength in a first range from about 380 nm to about 435 nm.

20. The LED lighting system of claim 11, further comprising an encapsulating material overlaying at least some of the one or more LEDs, the encapsulating material comprising a material selected from silicone, epoxy, and a combination thereof.
